(19) United States
(12) Patent Application Publication
(10) Pub. No.: US 2010/0070200 A1
(43) Pub. Date: Mar. 18, 2010

(54) Method and system for designing polypeptides and polypeptide-like polymers with specific chemical and physical characteristics

(76) Inventors: Mehmet Sarikaya, Seattle, WA (US); Candan Tamerler-Behar, Seattle, WA (US); Ersin Emre Oren, Seattle, WA (US); Vaikuntanath V. Samudrala, Mukilteo, WA (US)

Correspondence Address: OLYMPIC PATENT WORKS PLLC, P.O. BOX 4277, SEATTLE, WA, 98104, US

(21) Appl. No.: 12/284,017

(22) Filed: Sep. 17, 2008

(51) Int. Cl. G06G 7/48; G06F 19/00

(52) U.S. Cl. 702/30; 703/11

(57) ABSTRACT

Embodiments of the present invention are directed to methods and systems for designing polypeptides with specific affinities for particular substrates and substances, including inorganic substrates, surfaces, and substances. One method embodiment of the present invention includes identifying an initial set of polypeptide candidates, characterizing the initial candidates with respect to desired affinities and/or other physical and chemical characteristics, and using those characterizations for developing and refining a polypeptide-scoring function that can then be applied to computationally generated polypeptide sequences in order to identify additional candidate polypeptide sequences.

### STATEMENT OF GOVERNMENT INTEREST

This invention has been made with Government support under Contract No. GM068152, awarded by the National Institutes of Health; Contract No. DMR 0520567, awarded by the National Science Foundation; and Contract No. DAAD19-01-1-0499 (ARO-DURINT) awarded by the U.S. Army Research Office. The government has certain rights in the invention.

### TECHNICAL FIELD

The present invention is related to materials science and, in particular, to the design and application of polypeptides and polypeptide-like polymers with specific chemical and physical properties, including specific affinities for particular substrates, surfaces, or substances.

### BACKGROUND OF THE INVENTION

Enormous progress has been made, in the past several hundred years, in understanding chemistry, physics, and materials science. Practical and theoretical understanding of chemical and physical phenomena have, in turn, led to enormous advances in the design, manufacture, and use of many different types of synthetic chemicals and materials, including polymers and alloys, pharmaceuticals, and inorganic and organic components of integrated circuits and other specialized devices and products. Empirical approaches to the design and manufacture of chemicals and materials has been, and continues to be, replaced by sophisticated theoretical and computational methods for designing new, useful materials and chemicals as well as for designing the synthetic steps and manufacturing processes for their production and applications.

Polypeptides, short polymers of amino-acid monomers, occur as many different natural products and are ubiquitous in living organisms. Probably the most important class of biomolecules, proteins, are longer polymers of amino acids, often containing multiple single-chain amino-acid polymers folded into exquisitely complex structures held together through specific electrostatic interactions, non-covalent bonding, hydrophobic interactions, and covalent bonds. The study of polypeptides and proteins has produced a great deal of information on protein structure and function, as well as automated synthetic methods and equipment that allow specific polypeptides to be efficiently synthesized at extremely high purity levels.

There are 20 amino-acid monomers commonly found in naturally occurring polypeptides and proteins, and many, additional less-commonly occurring natural amino-acid monomers and synthetic amino-acid monomers. Even the common 20 amino acids feature a variety of side-chain functional groups and structures, which, in turn, confer many different possible chemical, physical, and structural properties to polypeptides. The physical, chemical, and structural properties of a polypeptide essentially depend on the sequence of amino-acid subunits within the polypeptide. Considering only the 20 commonly occurring amino acid subunits, there are an enormous number of different possible small polypeptide sequences. For example, there are over three million possible polypeptides with five amino-acid subunits. Because of the huge number of different types of even relatively modestly sized polypeptides, polypeptides can be designed with an enormous variety of different physical and chemical characteristics. However, the enormous number of different possible polypeptides, even considering only the 20 common amino acid subunits, presents a computational and design challenge. It is impractical and, in general, impossible to synthesize and test each possible polypeptide's chemical and physical properties. Therefore, even though it may be reasonably assumed that, for any reasonable set of desired physical and chemical characteristics, some number of polypeptides exist which exhibit the desired set of characteristics, determining the amino-acid sequence of one or more polypeptides which exhibit the desired set of characteristics may be difficult.

There are many applications for which it would be useful to design and produce specific polypeptides for binding to particular substrates, surfaces, or substances with high affinity. With the advent of nanotechnology, molecular electronics, and molecular medicine, the ability to produce binding agents with very specific binding properties for particular substrates, including inorganic substrates, and particular substances has become increasingly important. The feature and component sizes of integrated circuits and other electronic devices are, for example, being relentlessly pushed well below the submicroscale range of sizes, where conventional photolithographic techniques can no longer be applied to manufacture the features and components. Instead, a variety of nanotechnology methods are being developed for manufacturing and manipulating nanoscale features and components, including methods based on self assembly of molecular components. The design and production of polypeptides with specific affinity for particular substrates, surfaces, and substances and, in certain cases, specific lack of affinity for other substrates, surfaces, and substances, may be an essential tool for developing methods for producing and manipulating submicroscale and nanoscale components and features for molecular-electronics devices, nanoscale electromechanical devices, and even bulk substances containing designed nanoscale components. Polypeptides may be used for masking, binding, coating, and functionalizing submicroscale and nanoscale components, and may facilitate self-assembly and directed assembly of macromolecular and nanoscale components and particles into useful structures and devices.

There are both practical and theoretical reasons to suspect that polypeptides may be important materials in emerging and future technological applications. In addition, polypeptides may also find wide and critical application in bioengineering, pharmaceuticals, medical science, and other areas. However, the enormous number of possible polypeptide candidates for any particular application, and the current inability to design polypeptide sequences with desired physical and chemical properties, presents a difficult problem. Therefore, materials scientists, researchers and developers of methods and materials in a variety of different technical fields and applications, and potential users of those applications and of products produced by those applications all recognize the need for efficient and reliable methods for designing polypeptides for specific applications.

### SUMMARY OF THE INVENTION

Embodiments of the present invention are directed to methods and systems for designing polypeptides with specific affinities for particular substrates and substances, including inorganic substrates, surfaces, and substances. One method embodiment of the present invention includes identifying an initial set of polypeptide candidates, characterizing the initial candidates with respect to desired affinities and/or other physical and chemical characteristics, and using those characterizations for developing and refining a polypeptide-scoring function that can then be applied to computationally generated polypeptide sequences in order to identify additional candidate polypeptide sequences.

### BRIEF DESCRIPTION OF THE DRAWINGS

FIG. 1A shows the general structure of an α-amino acid and an α-imino acid.

FIG. 1B provides a table of the common α-amino acids and α-imino acid.

FIG. 1C shows three different ionic forms of an amino acid that may exist alone or in combination in solutions of different pH.

FIG. 1D illustrates the tetrahedral nature of a carbon atom covalently bound to four substituents.

FIG. 1E illustrates the conformations of two different possible stereoisomers of an amino acid with respect to the C_{α} position within the amino acid.

FIG. 2A illustrates polymerization of three amino acids to form a polypeptide.

FIG. 2B shows a planar arrangement of four background atoms and two substituents of background atoms within a polypeptide polymer.

FIG. 2C shows planar arrangements of atoms along a polypeptide chain.

FIG. 2D illustrates Φ and ψ torsion angles.

FIG. 3 shows a Ramachandran plot of Φ/ψ torsion angles for each C_{α} carbon in a right-handed a helix.

FIG. 4 illustrates a small section of right-handed a helix.

FIG. 5 illustrates a small region of β-pleated-sheet secondary structure.

FIGS. 6A-B illustrate one of the proposed binding mechanisms of two seven-amino-acid peptides, SD152 and SD60, to a platinum {110} crystallographic surface.

FIGS. 7A-C provide control-flow diagrams that describe a polypeptide-binder design method that represents one embodiment of the present invention.

FIG. 8A illustrates a similarity matrix S for polypeptides containing the 20 commonly occurring amino acids.

FIG. 8B shows the BLOSUM62 similarity matrix computed from comparisons of many different protein sequences.

FIG. 9 illustrates an aligned-sequence scoring function computed repeatedly during intermediate steps in the computation of a pairwise similarity score.

FIG. 10 shows the score matrix F and traceback matrix T used in a sequence-alignment method underlying the pairwise similarity score.

FIG. 11 shows a first step in the alignment process underlying the pairwise similarity score.

FIGS. 12A-C illustrate sequential generation of element values for the score matrix F and trace matrix T during the course of the sequence alignment computation.

FIG. 13 illustrates the basic element-value-generating operation for elements of the score matrix F and traceback matrix T following the initialization step illustrated in FIG. 11.

FIG. 14 illustrates determination of the best alignment and corresponding alignment score for two sequences.

FIG. 15 illustrates the total similarity score that is employed in a polypeptide scoring function used in certain embodiments of the present invention.

FIG. 16 illustrates a variant of the total similarity score, referred to as the self-TSS or “STSS,” in which a numeric value is computed by comparing members of a set of sequences with one another.

FIG. 17 illustrates one, particular embodiment of the present invention for designing polypeptides with particular binding characteristics, affinities for particular substrates, surfaces, or substances, or with some other well-defined chemical or physical characteristics.

FIG. 18 illustrates a different type of similarity matrix that may be used in an alternate PSS.

FIG. 19 provides a control-flow diagram for one particular embodiment of the present invention.

FIGS. 20A-D illustrate anisotropic properties of certain crystalline substances.

FIGS. 21A-C illustrate a polypeptide-based approach to efficient immobilization of catalytic crystals.

FIGS. 22A-H illustrate a second application for polypeptide binders having specific, high affinities for particular substrates.

### DETAILED DESCRIPTION OF THE INVENTION

Method and system embodiments of the present invention are directed to the design of polypeptides with particular physical and chemical characteristics. In particular, method and system embodiments of the present invention may be applied to design polypeptides with high specific affinities for particular substrates and substances and/or lack of affinity for other substances and substrates. However, in general, method and system embodiments of the present invention may be used to design polypeptides to have any desired, specific physical and chemical characteristics for which the polypeptides may be tested experimentally for and which an objective function can be devised to direct optimization of a polypeptide-scoring functions.

### Overview of Polypeptides

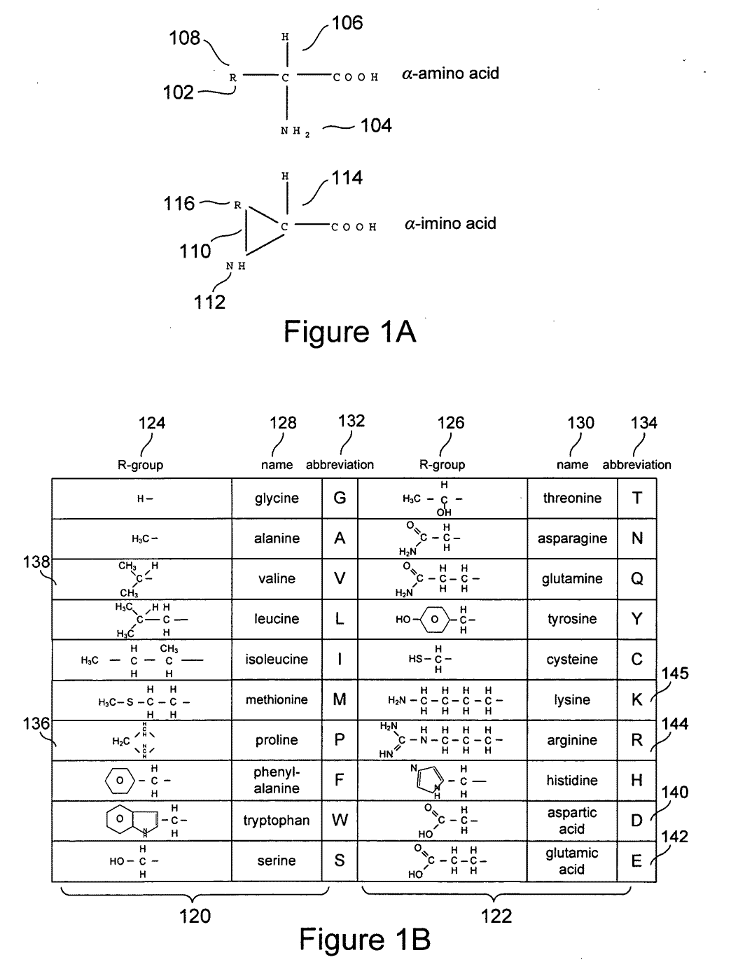

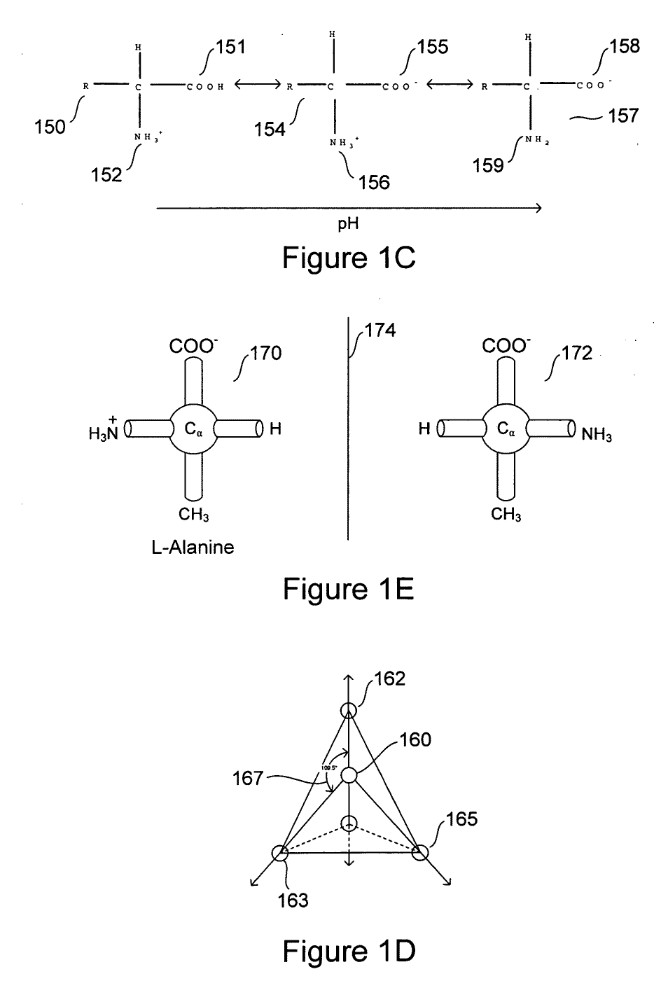

Naturally occurring polypeptides and proteins are, for the most part, polymers of 19 common amino acids and one common imino acid. FIG. 1A shows the general structure of an α-amino acid and an α-imino acid. An α-amino acid is a carboxylic acid 102 with an amino substituent 104 at the α-carbon position 106. Each of the 19 common α-amino acids have this general structure, and differ from one another by having different R-group substituents 108 at the α-carbon position 106. An α-imino acid 110 has a similar structure, except that the α-imino nitrogen 112 is covalently bound both to the a carbon 114 and to the R-group substituent 116 of the α carbon.

FIG. 1B provides a table of the common α-amino acids and α-imino acid. This table includes two three-column listings of the common α-amino acids and α-imino acid. Each three-column listing 120 and 122 provides the structure of the R-group 124 and 126, or side chain, the name of the α-amino or α-imino acid 128 and 130, and a single-character abbreviation for the α-amino or α-imino acid 132 and 134. The single α-imino acid is named “proline” 136. Certain of the α-amino acids have non-polar, aliphatic, hydrophobic R groups, such as valine 138. Other of the α-amino acids have acidic, generally negatively charged R groups, such as aspartic acid 140 and glutamic acid 142, or basic, generally positively charged R groups, such as arginine 144 and lysine 145. Other amino acids feature hydroxyl, sulfydryl, and aromatic side groups. In addition to the common α-amino and α-imino acids listed in FIG. 1B, naturally occurring peptides and proteins may additionally contain various derivatives of these α-amino acids as well as various unusual, infrequently encountered amino acids.

In solution, an amino acid may have any of various different ionic forms. FIG. 1C shows three different ionic forms of an amino acid that may exist alone or in combination in solutions of different pH. At low pH, a positively charged ionic form 150 predominates, in which both the carboxylic-acid group 151 and amino group 152 are protonated. At an intermediate pH, a Zwitterionic form 154 predominates, in which the carboxylic acid 155 is deprotonated while the amino group 156 remains protonated. At high pH, a negatively charged ionic form 157 predominates in which the carboxylic acid group 158 and amino group 159 are both deprotonated. Of course, a particular amino acid may have additional ionic forms, when the R group contains additional acidic or basic substituents. For example, the R group of lysine (145 in FIG. 1B) includes an amino group that is protonated at low pH and intermediate pH and deprotonated at high pH.

FIG. 1D illustrates the tetrahedral nature of a carbon atom covalently bound to four substituents. In particular, the carbon atom at the a position within an amino acid (106 and 114 in FIG. 1A) 160 can be thought of as positioned within a regular tetrahedron, with substituents positioned at each vertex of the tetrahedron 162-165. As indicated in FIG. 1D by the curved arrow 167, the angle between any two bonds joining a substituent to the C_{α} carbon atom is 109.5°.

FIG. 1E illustrates the conformations of two different possible stereoisomers of an amino acid with respect to the C_{α} position within the amino acid. Because of the tetrahedral nature of the C_{α} atom, and because the C_{α} atom generally has four different, distinct substituents (except for glycine), amino acids, other than glycine, are stereoisometric at the C_{α} position. As shown in FIG. 1E, the two stereoisomers 170 and 172 are related to one another by mirror-plane symmetry 174. In other words, reflection of one stereoisomer in a mirror generates the other stereoisomer. The L stereoisomer 170 is most frequently encountered in biological materials, and almost all naturally occurring proteins include only L stereoisomers of amino acids. The D stereoisomer 172 is observed in racemic mixtures obtained as the product of organic synthesis, when stereoisometry is not controlled by reaction conditions, and is occasionally encountered in biological materials such as cyclic peptide antibacterials and ionophors.

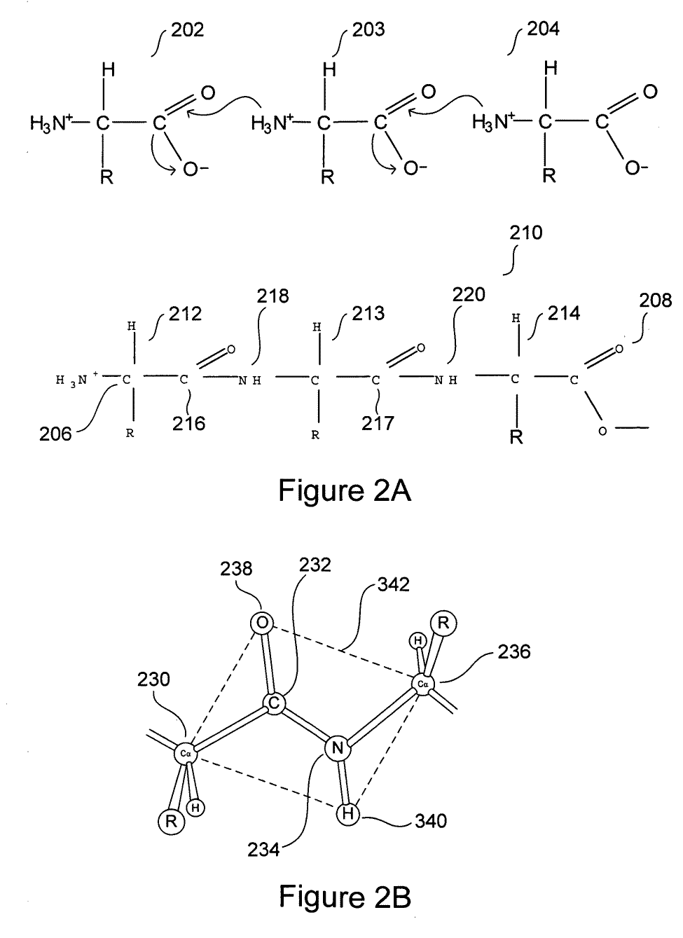

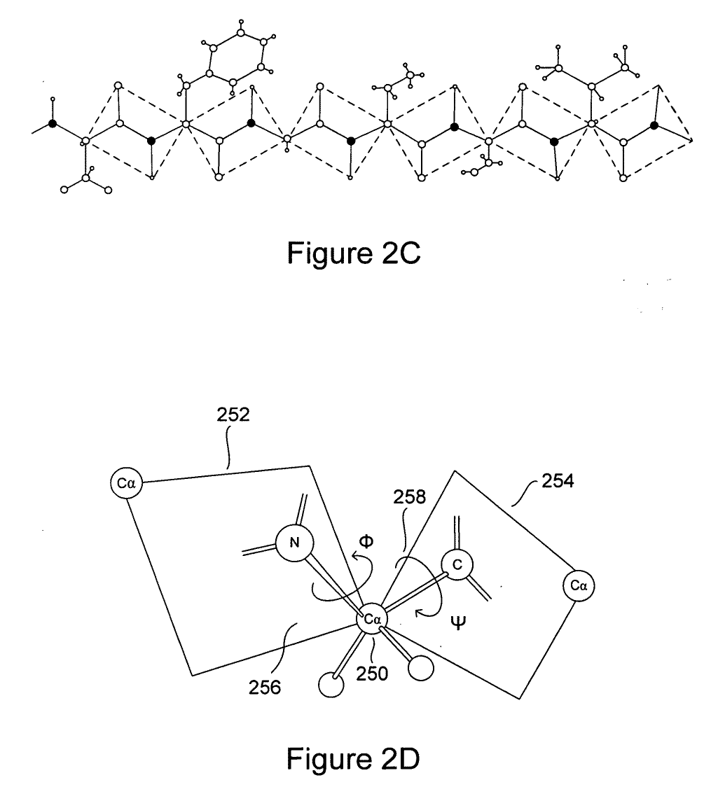

FIG. 2A illustrates polymerization of three amino acids to form a polypeptide. Amino acids 202-204 can, under proper conditions, undergo a condensation reaction by which the amine nitrogen on a first amino acid displaces a carboxylic-acid-group oxygen on a second amino acid to form an amide bond. Thus, amino acids are monomers within polypeptide polymers. In biological organisms, most polypeptides are synthesized by a ribosome-and-tRNA-mediated mRNA translation process. Proteins are large biopolymers consisting of one or more separate polypeptide chains. Normally, polypeptide sequences are written with the free-amino-group containing amino acid 206 on the left-hand side and the free-carboxylic-acid-containing amino acid 208 on the right-hand side. The polypeptide backbone consists of repeating 3-atom sequences that each includes a C_{α} atom, a carbonyl-carbon atom, and an amide nitrogen atom, and is generally represented as a linear, horizontal sequence, although, as discussed below, the backbone conformation is actually non-linear. Thus, in the three-amino-acid polypeptide 210 shown in FIG. 2A, the polypeptide backbone comprises C_{α} carbons 212-214, carbonyl carbons 216 and 217, and amide nitrogens 218 and 220. Polypeptide structures are generally written with R-group substituents vertically displaced from the C_{α} carbons, although that convention does not reflect actual spatial directions of the bonds or spatial positions of the atoms.

FIG. 2B shows a planar arrangement of four background atoms and two substituents of background atoms within a polypeptide polymer. FIG. 2B shows a short stretch of a polypeptide-backbone structure beginning with a first C_{α} atom 230 and extending through a carbonyl carbon 232 and amide nitrogen 234 to a second C_{α} atom 236. Because of delocalization of π electrons of the carbonyl group over the amide bond, the four backbone atoms shown in FIG. 2B, along with the carbonyl oxygen 238 and amide hydrogen 240, are all approximately planar, and located within the plane described by dashed lines 242 in FIG. 2B. FIG. 2C shows planar arrangements of atoms along a polypeptide chain using the same dashed-line convention as used in FIG. 2B.

FIG. 2D illustrates Φ and ψ torsion angles. Because of the planar arrangement of many of the backbone atoms, as shown in FIG. 2C, the conformation of a polypeptide backbone is fully specified by two torsion angles with respect to each C_{α} carbon in the polypeptide backbone. As shown in FIG. 2D, each C_{α} carbon 250 lies at the vertices of two different planar regions 252 and 254. The torsion angle Φ 256 about the amide bond and the torsion angle ψ 258 about the C_{α}-carbonyl-carbon bond describe all possible arrangements of the adjacent planar regions with respect to the C_{α} bond 250 lying at vertices of both planar regions. By specifying the Φ and ψ torsion angles for each C_{α} along a polypeptide backbone, any possible polypeptide-backbone conformations can be fully specified.

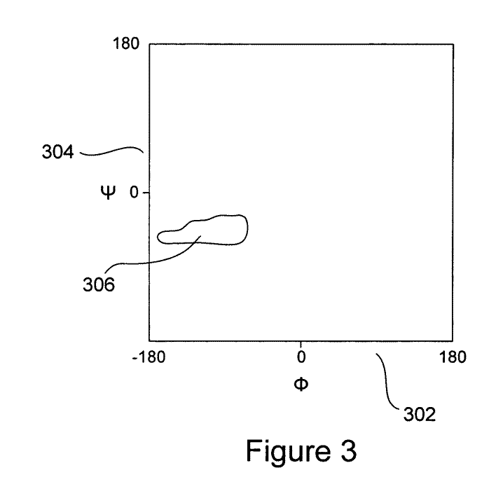

Polypeptides and proteins are generally not linear structures, but are instead folded into elaborate three-dimensional structures that often contain regions of well-defined secondary structure. Two commonly encountered types of secondary structure are a helices and β-pleated sheets. These regular, secondary-structure conformations of polypeptides can be described as a constraining of the Φ and ψ torsion angles along the polypeptide chain to narrow ranges of values. FIG. 3 shows a Ramachandran plot of Φ/ψ torsion angles for each C_{α} carbon in a right-handed a helix. The Φ angles are plotted with respect to a Φ axis 302 and the ψ angles are plotted with respect to a ψ axis 304. For a right-handed α-helix, the possible Φ/ψ angle pairs for each C_{α} carbon fall within a small region 306 of the area of the Ramachandran plot representing all possible Φ/ψ angle pairs.

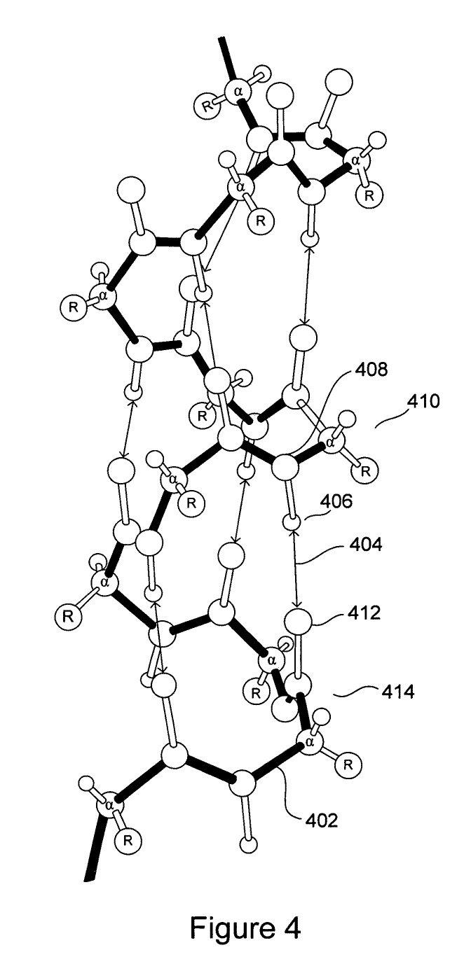

FIG. 4 illustrates a small section of right-handed a helix. In FIG. 4, the backbone bonds, such as bond 402, are shaded to prominently display the helix formed by the polypeptide backbone about an approximately vertical axis. The helix structure is stabilized by hydrogen bonds, indicated in FIG. 4 by double-headed arrows, such as hydrogen bond 404. Each hydrogen bond is a weak electrostatic bond in which an amide hydrogen is shared between the weakly acidic amide and a weakly basic carbonyl oxygen. In the α-helix structure, the amide hydrogen 406 is covalently bound to an amide nitrogen 408 of a first amino-acid monomer 410, and the amide hydrogen 406 is shared with the carbonyl oxygen 412 of a second amino-acid residue 414 displaced by four residues from the first amino acid along the polypeptide backbone.

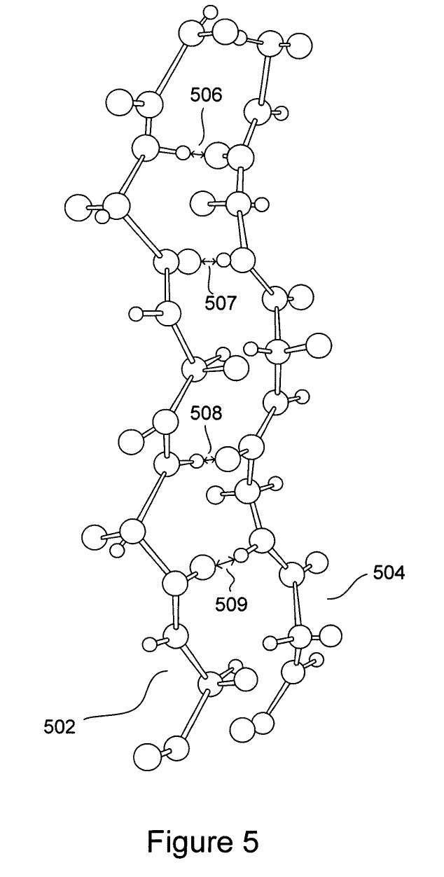

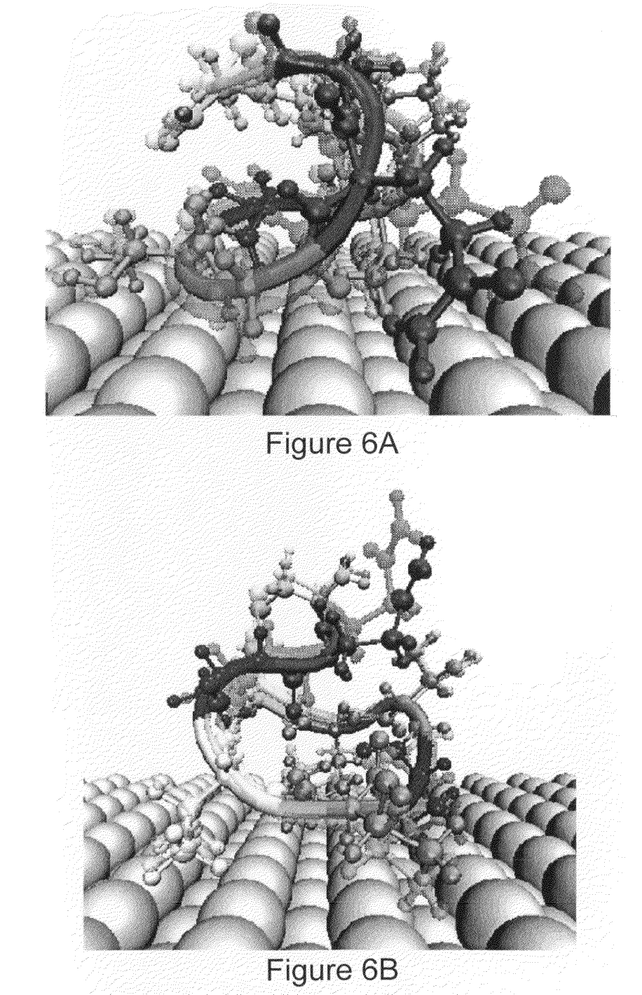

FIG. 5 illustrates a small region of β-pleated-sheet secondary structure. In FIG. 5, two polypeptide strands 502 and 504 are laterally displaced from one another, and held in a stable, roughly parallel arrangement by inter-strand hydrogen bonds 506-509. The polypeptide strands may be two portions of a single polypeptide chain, or may be portions of two different polypeptide chains. The β-pleated-sheet motif can be extended laterally to produce a pleated-sheet-like structure. Note that, along each strand of the β-pleated-sheet structure, carbonyl oxygens are alternately displaced toward the opposite strand and away from the opposite strand. Carbonyl bonds have significant dipole moments, but because the carbonyl bonds alternate in direction by approximately 180°, the dipole moments tend to cancel one-another over the length and width of the β-pleated-sheet structure.

Polypeptides, generally having lengths up to 50 amino-acid subunits, are shorter than most protein polymers, and often have somewhat more flexible and less well-defined three-dimensional confirmations. However, in certain cases, the three-dimensional confirmation of even short polypeptides may be well defined and stable. Furthermore, when polypeptides bind to, or associate with, various substrates, surfaces, and substances, specific binding interactions between the polypeptides and the surfaces and substrates may further define and constrain the three-dimensional structure of the polypeptides. As with proteins, the amino-acid sequence of a polypeptide specifies both the observed three-dimensional structure or structures of the polypeptide as well as the physical and chemical characteristics of the polypeptide. Polypeptides that exhibit extremely high affinities and specificities for particular substrates and surfaces, including various inorganic substrates and surfaces, including quartz, hydroxyappetite, and gold, have been identified by method embodiments of the present invention.

FIGS. 6A-B illustrate one of the proposed binding mechanisms of two seven-amino-acid peptides, SD152 and SD60, to a platinum {110} crystallographic surface. The polypeptide SD152 has the sequence “PTSTGQA” and the polypeptide SD60 has the sequence “QSVTSTK.” Computational conformational analysis (Molecular Dynamics) produced the three-dimensional structures for SD152 and SD60 shown in FIGS. 6A-B, respectively. An energy-minimization computation produced the specific binding interactions between the seven-amino-acid peptides and the platinum crystallographic surface shown in FIGS. 6A-B. As shown in FIGS. 6A-B, the platinum crystallographic surface in the {110} orientation exhibits periodic troughs and crests in one direction and is reminiscent of the surface of a corrugated metal panel. Particular amino-acid side chains are oriented such that various amino-acid-side-chain groups with affinities for the platinum surface lie within the troughs of the platinum surface, maximizing association with the platinum surface and potentially stabilizing the polypeptide with respect to the platinum surface. The strength of binding of particular polypeptides to particular surfaces may be described by a complex function that takes into account the three-dimensional structure of the polypeptide, complementarity of that structure with features and periodicities of the surface or substrate to which the polypeptide binds, the charge, polarity, aromaticity, and other physical and electrostatic properties of side-chain groups that associate with the substrate or surface, the ratio of surface area of the polypeptide proximate to the substrate or surface to the total volume of the polypeptide structure, and dynamical properties of the polypeptide. In many cases, the forces, associations, and features that contribute to polypeptide binding to substrates and surfaces are not well understood. Therefore, many of the particular polypeptides with strong affinities for particular surfaces, substrates, and substances have been identified by empirical, experimental methods, rather than having been designed to exhibit the particular affinities to particular substrates, surfaces, and substances. Nonetheless, it is clear that it should be possible to identify polypeptides with specific affinities for arbitrary substrates, surfaces, and substances.

### Design of Polypeptides with Specific Physical and Chemical Characteristics

One possible, although extremely naive, approach to designing polypeptides with specific binding characteristics would be to computationally generate all possible polypeptide sequences within some range of polypeptide lengths, synthesize polypeptides having the computationally generated sequences, and to then test the polypeptides for their binding properties. However, using only the 20 common amino acids, and computing sequences for polypeptides of lengths between seven amino acids and 12 amino acids, one would compute 4,311 trillion different polypeptide sequences, which, were it possible to synthesize and characterize each different polypeptide in one second, would nonetheless require over 136 million years to evaluate sequentially. Even massively parallel computation and characterization could nor possibly make this brute-force method practical. Even by eliminating the synthetic and analytical part of the problem, and relying solely on computational-theoretical techniques, a combinatoric approach would still not be feasible.

Method and system embodiments of the present invention employ a computational, synthetic, and analytical approach to carry out a partially directed, partially random search of polypeptide-sequence space, in general using an iterative approach involving incremental optimization of a polypeptide-scoring function. These methods, while not guaranteed to produce polypeptides with desired binding characteristics, have been found to be generally effective and, over time, may provide a bootstrap for future, even more effective methods that increasingly rely on computational, rather than synthetic and analytical, procedures. Since the synthetic and analytical procedures represent a clear bottleneck in throughput and time efficiency, future methods derived from the current methods and results obtained by current methods may provide dramatically increased efficiencies.

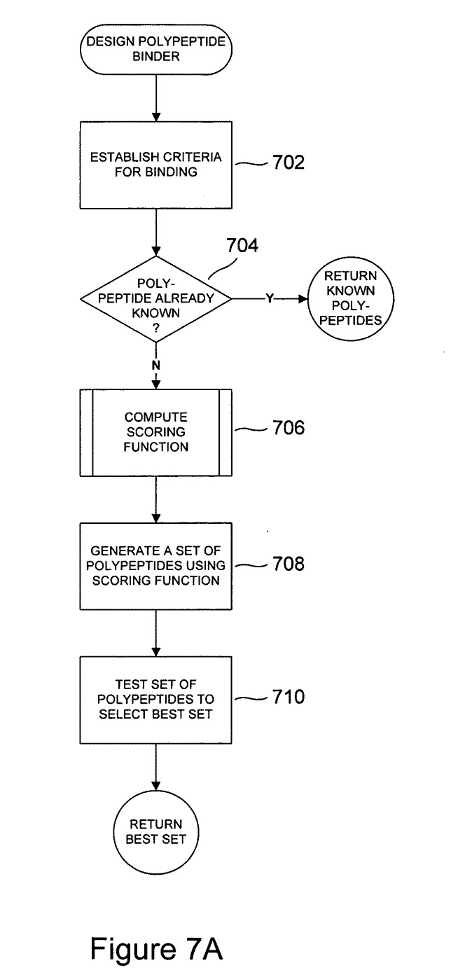

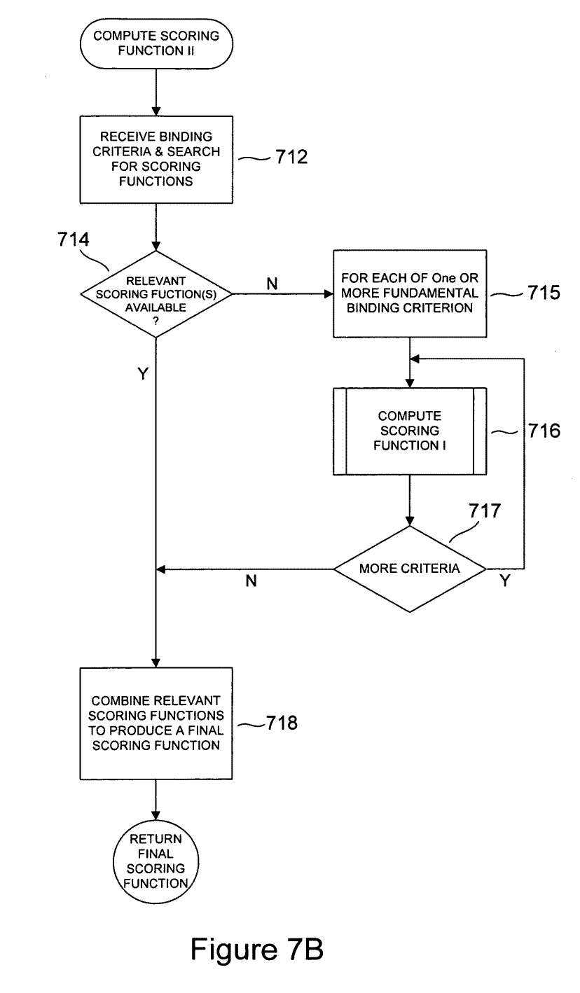

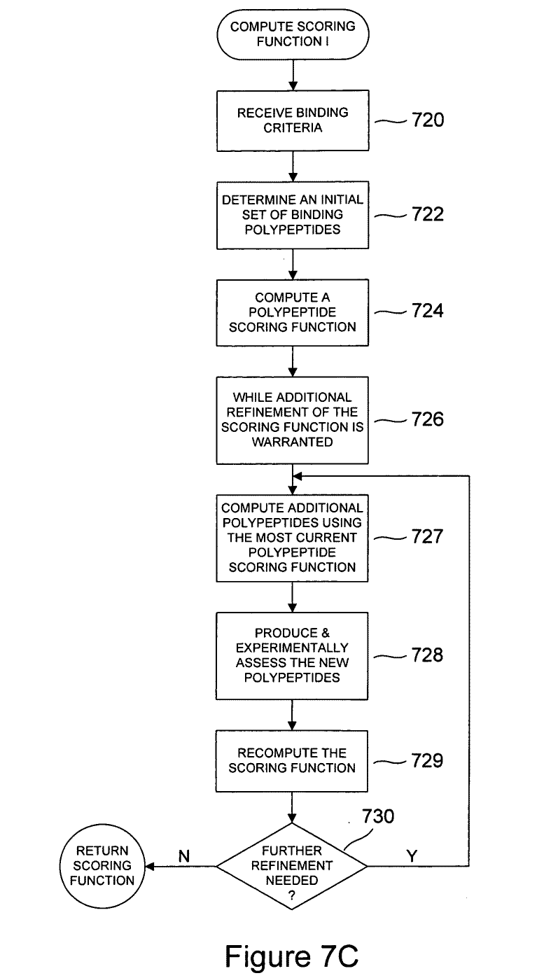

FIGS. 7A-C provide control-flow diagrams that describe a polypeptide-binder design method that represents one embodiment of the present invention. In a first step, shown in FIG. 7A 702, binding characterization is carried out on experimentally selected (e.g., in vivo phage display or cell surface display, or in vitor RNA display) polypeptides. A variety of different types of binding characterizations are possible. In simple cases, it may be desired to design a polypeptide that exhibits a binding constant within a well-defined range of binding constants towards a particular substrate, surface, or substance. In more complicated cases, the polypeptide that represents the goal of the design method may be desired to exhibit particular binding constants towards two or more different substrates, surfaces, or substances and, in addition, it may be desired that the polypeptide show little or no affinity for additional particular substrates, surfaces, or substances. Of course, as the types and numbers of design constraints increase, the number of iterations of method steps required to identify peptides with the desired characteristics may also increase.

Next, in step 704, a search may be carried out on a database of known polypeptide sequences and characteristics to determine whether any known polypeptides have the desired characteristics established in step 702. This is one point in the process that represents one embodiment of the present invention where the method may considerably improve, over time, as more and more polypeptides are designed and characterized.

Next, in step 706, a polypeptide scoring function that maps polypeptide sequences to integer or real-number scores is designed using the established binding criteria. Applied to a random polypeptide sequence, the polypeptide scoring function should return a value indicative of the degree to which the polypeptide having that sequence can be expected to exhibit the binding characteristics established in step 702. In a simple case, where a polypeptide that binds with high affinity to a particular substrate, surface, or substance is sought, a polypeptide scoring function, when applied to a polypeptide sequence, may return an integer value proportional to a theoretical binding constant computed for the polypeptide having the input polypeptide sequence. For more complex design goals, the polypeptide scoring function may produce a value reflective of two or more constraints, and thus not simply proportional to a particular binding constant. In other cases, the score may reflect sequence similarity of an input polypeptide sequence to the sequences of known polypeptides with the desired characteristics, or may reflect many additional types of considerations. In general, the larger the score returned by the polypeptide scoring function, the greater the probability that the polypeptide having the input polypeptide sequence will exhibit the desired characteristics.

Next, in step 708, a set of polypeptide sequences is generated using the computed scoring function. The scoring function may be applied, for example, to a series of randomly generated sequences, with those of randomly generated sequences producing the highest scores selected as an initial set of polypeptides computed according to the established binding criteria in step 702. The scoring function may additionally be applied to previously computed lists of polypeptide sequences, or may be applied to sequences generated by a more complex, computational process involving both random selection and selection based on various theoretical calculations and principals. Finally, in step 710, polypeptides having sequences of the set of polypeptides generated in 708 may be synthesized and experimentally analyzed in order to characterize the polypeptides and select one or more polypeptides that exhibit the most desirable binding characteristics and/or other characteristics represented by the criteria established in step 702.

FIG. 7B provides a control-flow diagram for a portion of the routine that computes the polypeptide scoring function, called in step 706 of FIG. 7A. In step 712, the established binding criteria are received. Also, in step 712, an electronic, computer-based search is conducted to find relevant scoring functions for the received binding criteria. For example, the binding criteria may specify that the desired polypeptide bind with high affinity to an amorphous silicon substrate, but show little or no affinity for gallium arsenide. It may be that a polypeptide scoring function has already been computed for these particular characteristics or, alternatively, separate scoring functions for high-affinity binding to amorphous silicon and for low affinity for gallium arsenide may have been previously computed. When relevant scoring functions are not available, as determined in step 714, then, in the loop comprising steps 715-717, one or more relevant scoring functions are computed. In step 718, relevant scoring functions may be combined to produce a final scoring function. In Continuing with the above example, it may be necessary to actually compute a single scoring function for high-affinity binding to amorphous silicon and no affinity for gallium arsenide. However, it may also be sufficient to use separate scoring functions for high-affinity binding to amorphous silicon and for low affinity for gallium arsenide, and then to computationally combine the separate scoring functions together to produce a polypeptide scoring function for the desired characteristics. This is yet another point where, over time, the described method may be significantly improved as more and more polypeptide scoring functions become available or are computed. For example, currently, there may be little available guidance as to how separate scoring functions that may be mathematically combined to produce a resultant scoring function suitable for a combination of constraints or characteristics. However, over time, as more and more scoring functions are computed or become available, the principles for such combination of scoring functions may be revealed, allowing for purely computational generation of polypeptide scoring functions suitable for complex desired characteristics and constraints. When no guidance is available, it may be initially necessary to compute a single scoring function suitable for each set of new received binding criteria.

FIG. 7C provides a control-flow diagram for a routine that computes a polypeptide scoring function, called in step 716 of FIG. 7B. In step 720, the desired binding criteria are received. These may be the same binding criteria received by the routine, shown in FIG. 7B, in step 712, or, alternatively, may be only a portion of those criteria. In step 722, an initial set of polypeptide sequences is determined. This initial polypeptide-sequence determination may be carried out in a variety of different ways. Various combinatoric-chemistry or combinatoric-biochemistry methods, such as phage-display-based methods, may be used to synthesize and characterize an initial set of polypeptides with binding characteristics approaching the binding criteria received in step 720. In the future, the initial set may be entirely computationally determined, using various structure-prediction and binding-constant prediction theoretical calculations. Next, in step 724, a polypeptide scoring function is computed from the initial set of polypeptides. In general, computing a polypeptide scoring function involves experimentally characterizing polypeptides having the initial set of polypeptide sequences and ranking the polypeptides in accordance with their binding characteristics. Then, a polypeptide scoring function is a computed that computationally orders the sequences according to their experimentally determined binding characteristics, or that at least classifies the sequences into some discrete number of binding classes that match experimentally determined binding classes. The scoring function can be evaluated computationally or both experimentally and computationally. While the polypeptide scoring function requires additional refinement, based on that evaluation, the steps of the while-loop, 726-730, may be iterated until an adequate scoring function is obtained. The iteration involves computationally generating additional polypeptide sequences and scoring those sequences using the current polypeptide scoring function, in step 727, experimentally characterizing the new polypeptides, in step 728, and recomputing the polypeptide scoring function based on both previously generated and characterized polypeptides and the newly generated and characterized polypeptides, in step 729.

In one embodiment of the present invention, the polypeptide scoring function employed for finding polypeptide sequences corresponding to polypeptides with desired physical and chemical characteristics is a total similarity score (“TSS”) used to compare one or more polypeptide sequences to a set of polypeptide sequences corresponding to known polypeptides with desirable characteristics. The TSS is, in turn, is based on a pairwise similarity score (“PSS”) computed using the Needleman-Wunsch sequence-alignment algorithm.

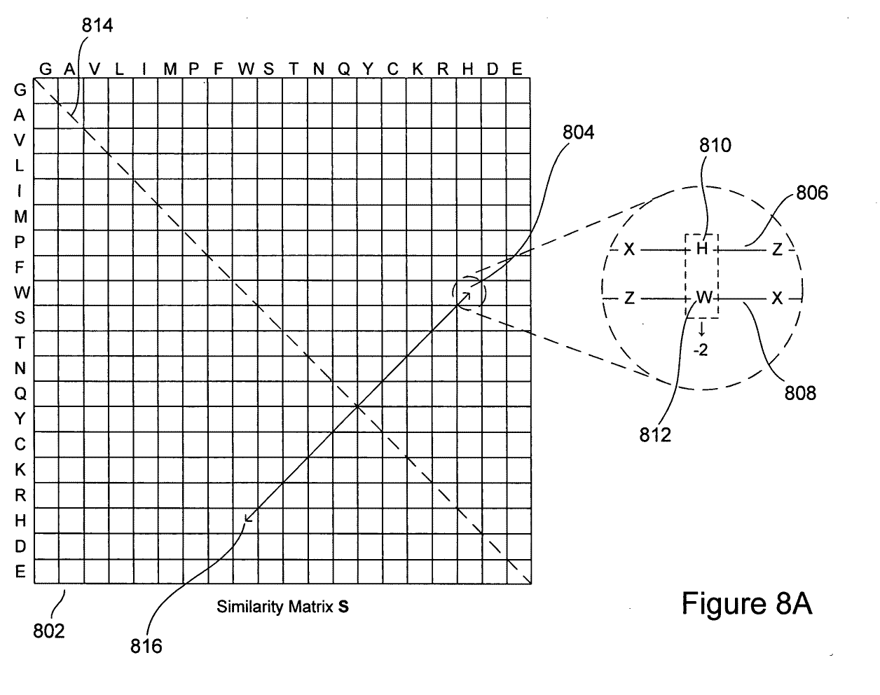

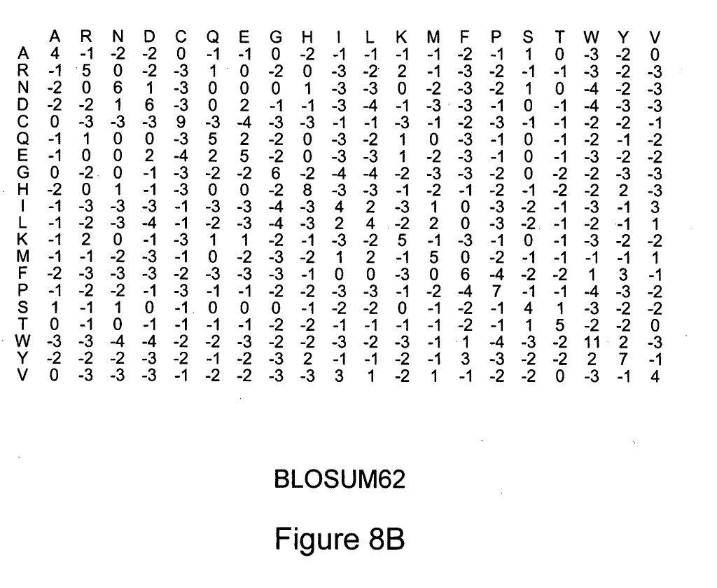

The PSS computation employs a similarity matrix. In the following discussion, the similarity matrix may be referred to, using familiar matrix notation, as “the similarity matrix S” or simply as “S.” FIG. 8A illustrates a similarity matrix S for polypeptides containing the 20 commonly occurring amino acids. As shown in FIG. 8A, the similarity matrix S can be thought of as a two-dimensional array 802, with rows indexed by each of the different 20 commonly occurring amino acids, illustrated in FIG. 8A using the single-character labels for the amino acids, and the columns also indexed by the 20 commonly occurring amino acids. Each element in the similarity matrix S, such as the element 804 in row W and column H, is a numeric value, generally an integer, representing the degree of similarity of the two amino acids that index the element when the indexing amino acids occur at the same position within two sequences that are being compared. For example, the numeric value for element 804, also referred to as a “cell” within the matrix, shown in FIG. 8A provides an indication of the similarity of the amino acids tryptophan, represented by the character “W,” and histidine, represented by the character “H.” When two sequences 806 and 808 are being compared, and when the amino acid histidine 810 occurs in the same position, in the first sequence 806, in which tryptophan 812 occurs in the second sequence 808, the integer value in similarity matrix S cell 804, “−2” in the illustrated example, indicates the degree of similarity of the two amino acids H and W. Note that the similarity matrix S is symmetric about the diagonal 814, so that the value in cell 804 is identical to the value in cell 816. Obviously, in computational implementations, only the unique values along and above or along and below the diagonal need to be stored.

Various different similarity matrixes S have been computed that express similarities between amino acids within aligned sequences. FIG. 8B shows the BLOSUM62 similarity matrix computed from comparisons of many different protein sequences. However, it is important to note that a similarity matrix S computed based on one set of comparisons may differ significantly from a similarity matrix S computed based on a different set of comparisons. For example, the sequences of a large number of protein kinase enzymes might be aligned, and a similarity matrix S computed based on frequency of occurrence of amino acids at each of the positions within the aligned sequences. Similarly, a similarity matrix S′ may be computed from a set of aligned sequences for various different dehydrogenase enzymes. It would be expected that the two similarity matrixes S and S′ may different from one another in a way that reflects differences in sequence commonalities of the two sets of sequences corresponding to the sequences of two different types of enzymes. In one enzyme, for example, a particular subsequence or a small set of related subsequences may occur at the active site in a highly conserved fashion, skewing the similarity-matrix values in one direction, while, in the other set of enzyme sequences, active site sequences are far less highly conserved and have very different subsequence motifs. In one embodiment of the present invention, BLOSUM62 or another general similarity matrix S computed from aligned protein sequences may be used as an initial starting point.

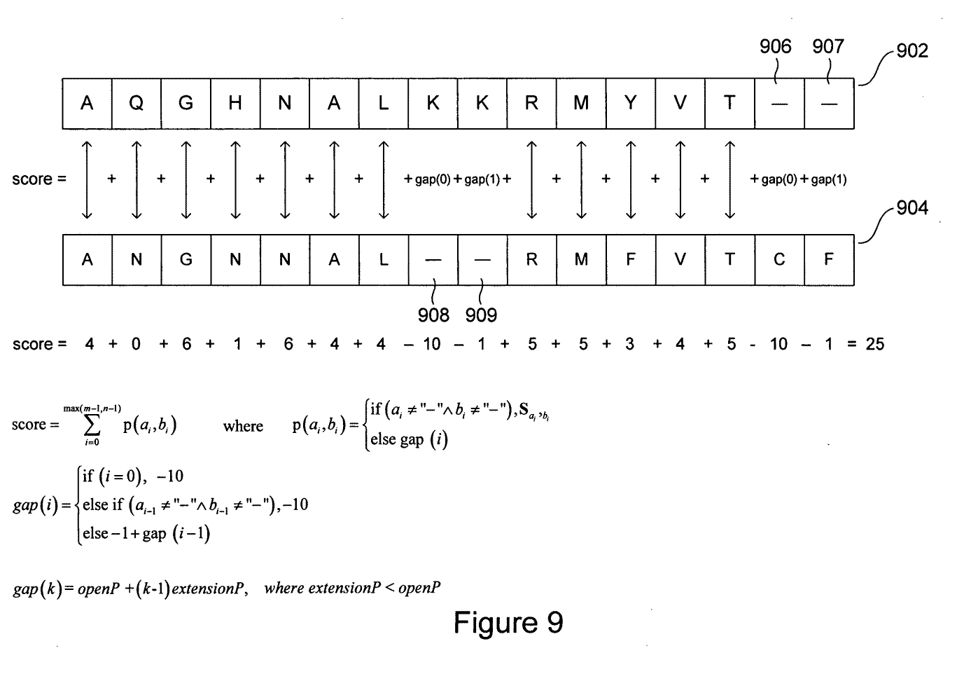

FIG. 9 illustrates an aligned-sequence scoring function computed repeatedly during intermediate steps in the computation of a PSS. In FIG. 9, a first polypeptide sequence 902 is aligned with a second polypeptide sequence 904. The single-character amino-acid symbols, discussed with reference to FIG. 1B, are employed. The special symbol “-” is used to indicate gaps in a sequence. For example, in FIG. 9, there is a two-symbol gap 906-907 at the right-hand end of the first sequence 902 and a two-symbol gap 908-909 in the middle of the second sequence 904. The alignment method underlying the PSS does not allow gaps at the same position in both sequences.

The alignment score is computed as:

$$score = {\sum }_{i = 0}^{max ( m - 1 , n - 1 )} p ( {a}_{i} , {b}_{i} )$$

$$where$$

$$p ( {a}_{i} , {b}_{i} ) = \{ \begin{matrix}if ( {a}_{i} \neq {}_{ }^{``} {-}_{ }^{″} ⋀ {b}_{i} \neq {}_{ }^{``}{-}{}_{ }^{″} ) , {S}_{{a}_{i}} {,}_{{b}_{i}} \\ else gap ( i )\end{matrix}$$

m=the length of the first sequence, including gaps; and

n=the length of the second sequence, including gaps.

In other words, the numeric value in the similarity matrix S for each aligned pair of amino acids is summed to produce the alignment score, with gaps assigned value generated by a gap function gap( ). In one embodiment of the present invention, an affine gap function is employed:

$$gap ( i ) = \{ \begin{matrix}if ( i = 0 ) , - 10 \\ else if ( {a}_{i - 1} \neq {}_{ }^{``} {-}_{ }^{″} ⋀ {b}_{i - 1} \neq {}_{ }^{``}{-}{}_{ }^{″} ) , - 10 \\ else - 1 + gap ( i - 1 )\end{matrix}$$

The first gap in a contiguous set of gaps, or a single gap bounded on both sides by amino acids, is assigned a large negative value, −10 in the example shown in FIG. 9. Any successive gap in a set of contiguous gaps is assigned the value −1. If a set of consecutive gap symbols occurs in a first sequence, and then, at a next position, a set of consecutive gap symbols begins in a second sequence, the first gap in the second sequence is assigned a penalty value of −10, while all successive gaps produce the penalty value “−1.” The concept behind the affine gap function is perhaps best expressed by:

gap(k)=openP+(k−1)extensionP

where openP=a gap-opening penalty and
extensionP=a gap-extension penalty.
   The first gap in a contiguous set of gaps is assigned a large gap-opening penalty, and all subsequent gaps assigned a smaller extension penalty. This favors alignments with no gaps over alignments with gaps, and favors alignments with a small number of large gaps over alignments with many small gaps.

The alignment method on which the PSS is based is next described. The description employs, in addition to the similarity matrix S, described above, two additional matrixes. The two additional matrixes are used primarily for illustration convenience. Actual implementations of the alignment method may use only a single additional matrix, inferring values shown as stored in the second additional matrix from values in the single additional matrix.

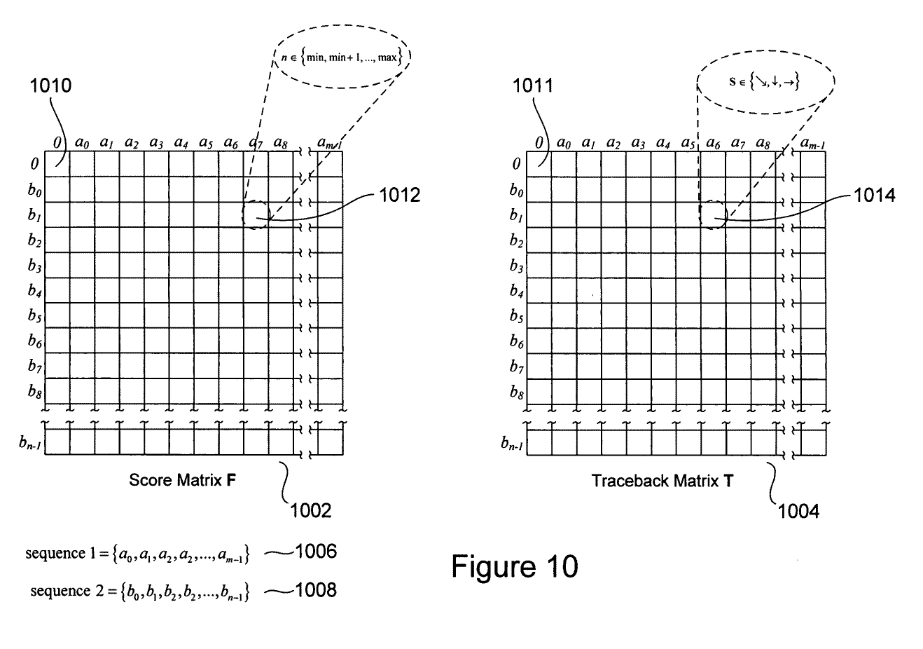

FIG. 10 shows the score matrix F and traceback matrix T used in a sequence-alignment method underlying the pairwise similarity score. Both the score matrix F 1002 and the traceback matrix T 1004 are indexed by the symbols of a first sequence and the symbols of a second sequence 1006 and 1008, as shown in FIG. 10, that are to be aligned by the method. Successive columns of the score matrix F and the traceback matrix T are indexed by successive symbols of the first sequence 1006, and successive rows in the score matrix F and traceback matrix T are indexed by successive symbols of the second sequence 1008. Note that the top, left-most cells in both arrays 1010-1011, have row and column indices {0,0}. The symbols in the sequences are, in a protein-sequence or polypeptide-sequence alignment method, the single-character amino-acid symbols, in N-terminal to C-terminal order, of protein or polypeptide sequences. The subscripts of the symbols in the sequences, in FIG. 10, reflect the position of the amino acid represented by the symbol within the protein or polypeptide sequence. Each cell in the score matrix F, such as cell 1012, contains a numeric value within a range of numeric values that represents the alignment score for one possible intermediate or complete alignment. Each cell in the traceback matrix T, such as cell 1014, contains one of the three symbols { [symbol] ↓,→}. Of course, in an actual implementation of the sequence-alignment method, the score matrix F indices are generally integers and the arrow characters used to illustrate values of elements of the traceback matrix T are generally represented as small integer values.

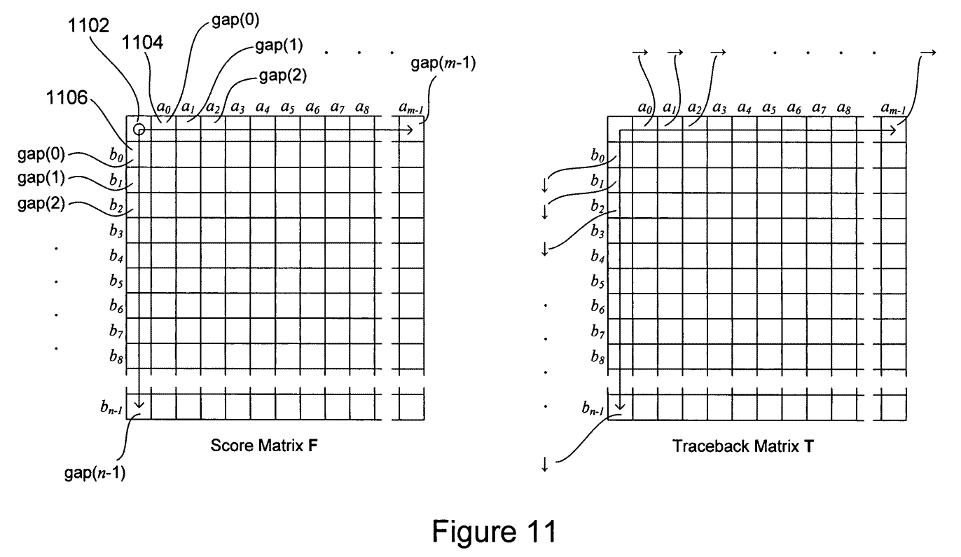

FIG. 11 shows a first step in the alignment process underlying the PSS. In the first step of the alignment process, the first row and column of both the score matrix F and the traceback matrix T are initialized. The topmost, left-hand cell 1102 of the score matrix F is initialized to the value “0.” The next cell in the first row 1104 and the next cell in the first column 1106 are each given the value gap(0), or, in other words, the value corresponding to the gap-opening penalty openP. Successive, following cells in the first row are given the values gap(1), gap(2), . . . gap(m−1), and each successive cell in the first column are given the values gap(1), gap(2), . . . gap(n−1). In the traceback matrix T, all of the cells in the first row, other than the left-most, top cell are given the values “→,” and all of the cells in the first column are given the values “↓.” The values in the score matrix F in the first row and first column reflect gaps of increasing length in the first and second sequences, respectively. The “→” and “↓” characters in the traceback matrix T indicate gap-introduction in the first and second sequences, respectively. Note that m and n are the lengths of the first and second sequences, respectively, without gaps.

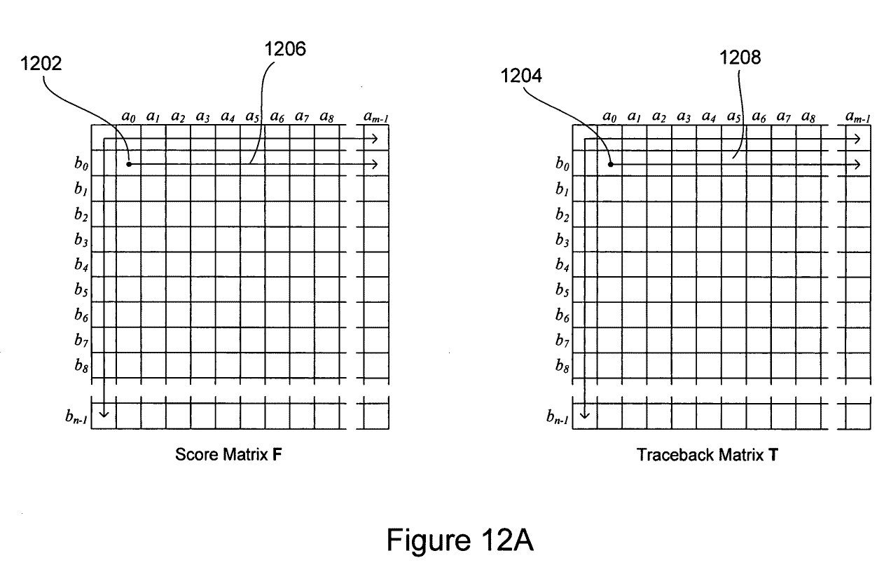

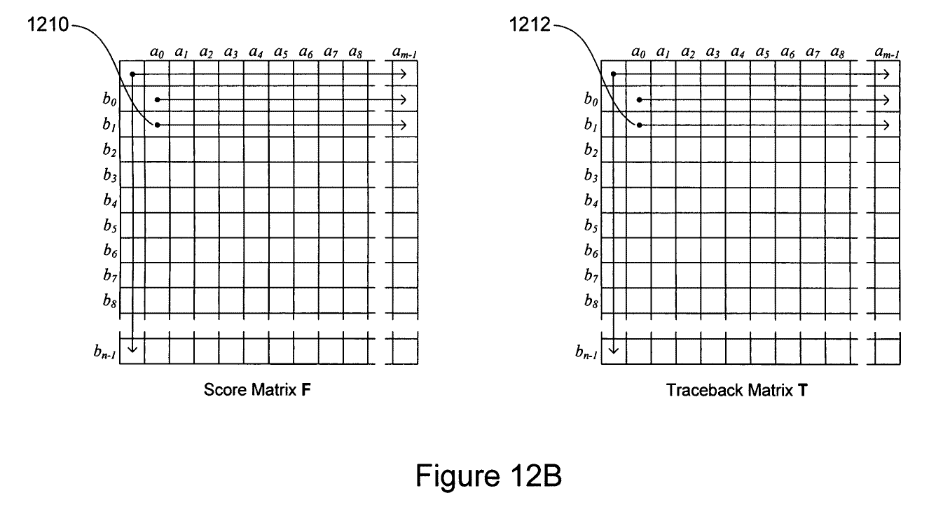

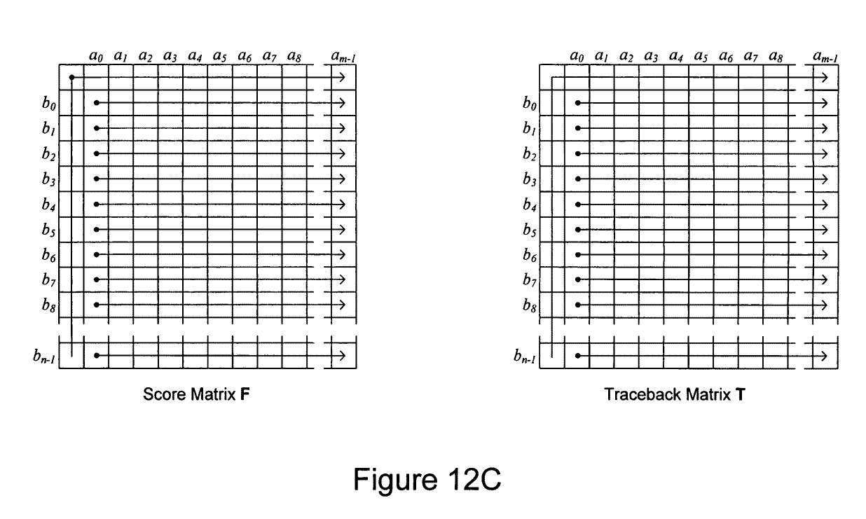

Once the score matrix F and traceback matrix T are initialized, the remaining cells in both matrixes are provided values. FIGS. 12A-C illustrate sequential generation of element values for the score matrix F and trace matrix T during the course of the sequence alignment computation. Following initialization, the next cell for which a value is generated in the score matrix in F is cell 1202, and the next cell for which a value is generated in the traceback matrix T is the corresponding cell 1204 in the traceback matrix T. As indicated by the horizontal arrows 1206 and 1208, following successive cells in the second rows of the score matrix F and traceback matrix T are generated. As shown in FIG. 12B, the third row of the score matrix F and traceback matrix T is next provided values, starting from cells 1210 and 1212, respectively. Values are generated, row by row, until the entire score matrix F and traceback matrix T are filled, as illustrated in FIG. 12C.

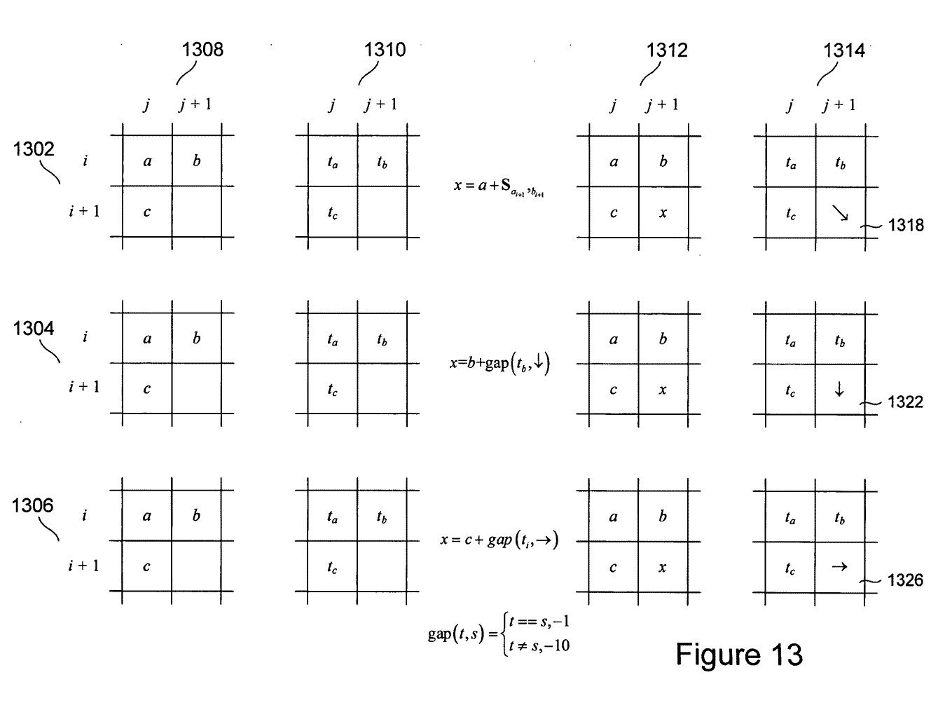

The same value-generating operation is performed for each successive cell in the score matrix F and traceback matrix T, following the initialization illustrated in FIG. 11. FIG. 13 illustrates the basic element-value-generating operation for elements of the score matrix F and traceback matrix T following the initialization step illustrated in FIG. 11. FIG. 13 shows three different possible cases in three horizontal rows 1302, 1304, and 1306. The first column in FIG. 13 shows small portions of the score matrix F 1308 and the second column 1310 shows small corresponding portions of the traceback matrix T. Similarly, the third column 1312 shows small portions of the score matrix F, and the fourth column 1314 shows corresponding small portions of the traceback matrix T. The first two columns illustrate empty, lower right-hand cells in the scoring matrix F and the traceback matrix T for each of which values are to be generated based on three adjacent, preceding cells in each of the two matrices. The second two columns show the values generated. There are three different possible values that may be generated, illustrated by the three horizontal rows 1302, 1304, and 1306 in FIG. 13. In the first case, the value for the cell in the score matrix F, x, is computed as:

x=a+Sₐ_{ᵢ₊₁}_{,b}_{ᵢ₊₁}

and the corresponding value in the traceback matrix T is the character “□” 1318. This value corresponds to increasing an intermediate, partial alignment represented by the cell (i,j) by one symbol in both the first and second sequences. In other words, the sequences have been previously aligned such that the i^{th} symbol in the second sequence is aligned with the j^{th} symbol in the first sequence, and the operation illustrated in horizontal row 1302 in FIG. 13 extends the aligned sequences by one symbol position. A second possibility, illustrated by row 1304 in FIG. 13, is to compute the score matrix F value as:

$$x = b + gap ( {t}_{b} , ↓ )$$

$$where$$

$$gap ( t , s ) = \{ \begin{matrix}t == s , - 1 \\ t \neq s , - 10\end{matrix}$$

and the corresponding value in the traceback matrix T is the symbol “→” 1322. This represents introducing a gap in the second sequence. A final possibility, illustrated by the final row 1306 in FIG. 13, is to introduce a gap in the first sequence, computing the score matrix F value as:

x=c+gap(tᵢ,→)

and setting the corresponding traceback matrix T value to “→” 1326.

In other words, FIG. 13 shows that each next value in the score matrix F and corresponding value in the traceback matrix T can be computed based entirely on the values of three adjacent, preceding values in the score matrix F and traceback matrix T. The value of the next score matrix F cell to be computed, x, is generated by one of the three operations illustrated in FIG. 13. All three operations are employed to compute all three possible values, and the operation which produces the maximum value is chosen as the operation to be applied to generate the values for the next cells of the score matrix F and traceback matrix T. This reflects the global driving force for sequence alignment, namely to produce a sequence with the maximum possible alignment score, where the alignment score is computed as discussed with reference to FIG. 9. When the score matrix F and traceback matrix T are completely filled by the above-discussed operations, the score matrix F contains alignment scores for all possible alignments of the first sequence with respect to the second sequence.

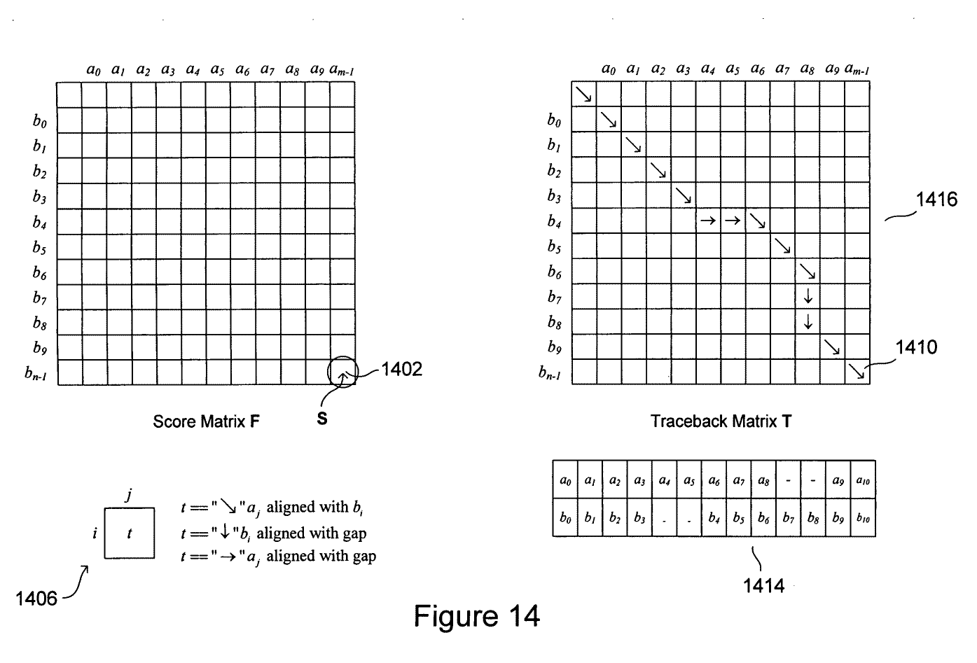

Once the score matrix F and traceback matrix T have been fully computed, as discussed above, determination of the best alignment between the first and second sequences is trivial. FIG. 14 illustrates determination of the best alignment and corresponding alignment score for two sequences. As shown in FIG. 14, the score for the best alignment is found in the lowest, right-hand cell 1402 of the score matrix F. The alignment can be generated from the last aligned position to the first aligned position using the traceback matrix T. The rule for traceback is illustrated with respect to an arbitrary cell (i,j) containing the value t 1406. If t= [symbol] then symbol aⱼ in the first sequence is aligned with symbol bᵢ in the second sequence. If t=““↓”,” then symbol bᵢ of the second sequence is aligned with a gap. If the symbol t=“→,” then the symbol aⱼ in the first sequence is aligned with a gap. One starts from the bottom, right-hand cell 1410 in the traceback matrix T and applies the above-discussed rule 1406 to generate the best possible alignment, reversing the arrows to decide which cell is next on the path. Using these rules, one can compute the alignment 1414 shown in FIG. 14 based on the values shown in traceback matrix T 1416. Note that all cells in the traceback matrix T have symbol values, but only the symbol values for a path followed by applying the above-discussed rule 1406 are shown in FIG. 14. Thus, to compute the PSS score for two polypeptide sequences, the method illustrated with reference to FIGS. 8A-14 is carried out in order to obtain the numeric score for the best possible sequence alignment, found in the bottom, right-most cell of the score matrix F.

The Needleman-Wunsch sequence alignment method is generally used for aligning sets of sequences to facilitate various types of sequence-based biological research. For example, when studying a newly discovered protein, one may gain insight into the protein's structure and function by attempting to align the sequence of the newly discovered protein with sequences of already characterized proteins. Once aligned, features of the newly discovered protein may be inferred by regions of subsequence similarity between the newly discovered protein and already-characterized proteins. However, the pairwise similarity score (“PSS”) produced as the best alignment score is, by itself, a numeric indication of the similarity between two sequences, particularly when an appropriate similarity matrix S is employed. When a set of polypeptide sequences has been experimentally characterized with respect to affinity for a particular substrate, surface, or substance, computing PSS scores for all possible pairs of sequences and analyzing the computed PSS scores with respect to the determined affinities can provide a basis for a polypeptide scoring function, useful in identifying additional polypeptide sequences of polypeptides that may exhibit desired characteristics and affinities.

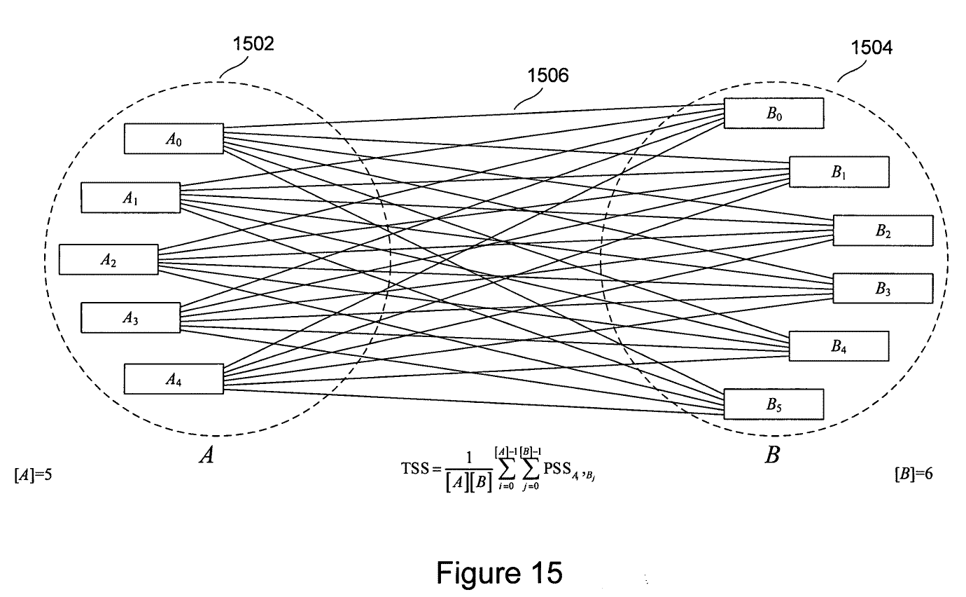

FIG. 15 illustrates the total similarity score that is employed in a polypeptide scoring function used in certain embodiments of the present invention. The total similarity score (“TSS”) may be computed between two different sets of polypeptide sequences as the normalized sum of all possible PSSs, where the PSSs are computed for pairs of sequences, one member of each pair selected from a first set and the other member of the pair selected from the second set. In other words, the TSS may be computed as:

$$T S S = \frac{1}{[ A ] [ B ]} {\sum }_{i = 0}^{[ A ] - 1} {\sum }_{j = 0}^{[ B ] - 1} {PSS}_{{A}_{i}} {,}_{{B}_{j}}$$

where A is a first set of sequences;

B is a second set of sequences;

[A] is the cardinality of set A; and

[B] is the cardinality of set B.

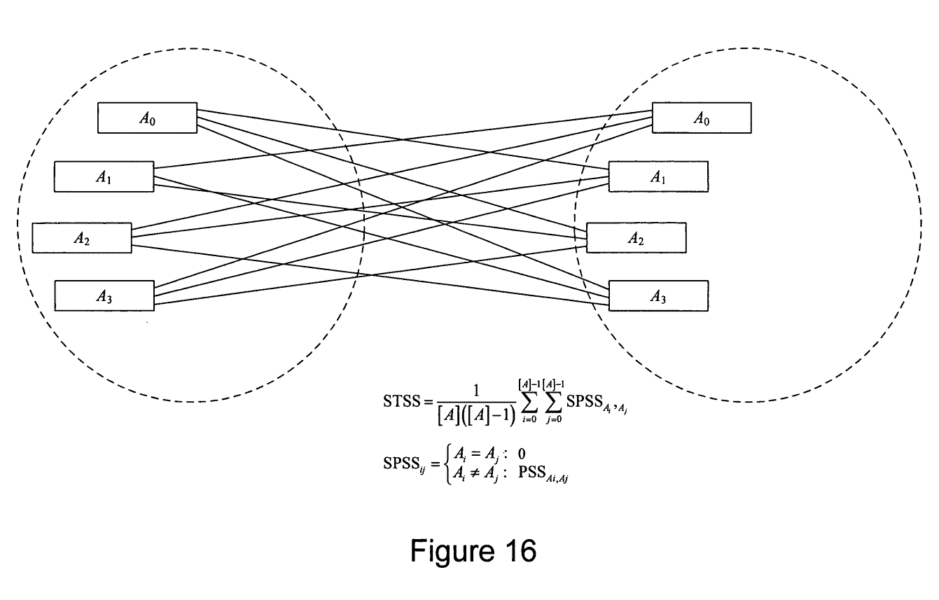

In FIG. 15, set A 1502 contains five members and set B 1504 contains six members. Lines are drawn between all possible pairwise combinations of members of set A with the members of set B. Each line, such as line 1506 in FIG. 15, represents a different PSS that is computed between members of the two sets in order to compute the TSS. The normalized sum of all these PSSs constitutes the TSS. FIG. 16 illustrates a variant of the TSS, referred to as the self-TSS or “STSS,” in which a numeric value is computed by comparing PSSs between members of a single set of sequences. However, in the case of the STSS, PSSs are not included for a member of the set compared against itself.

One possible polypeptide scoring function, useful in evaluating new, uncharacterized sequences, is to compute the TSS between the single-member set containing the new sequence and a set of known, already characterized polypeptide sequences corresponding to polypeptides with desired binding properties, affinities, or other characteristics. In essence, the higher the TSS score, the more similar the new, uncharacterized sequence is to the sequences corresponding to already evaluated polypeptides with a desirable characteristic or characteristics.

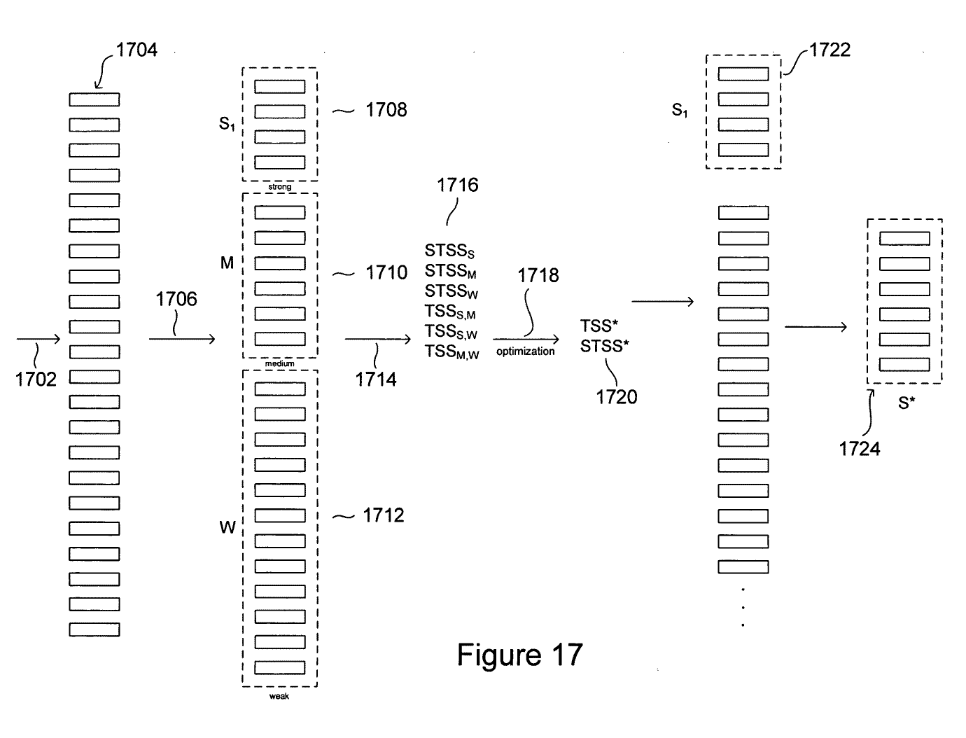

FIG. 17 illustrates one, particular embodiment of the present invention for designing polypeptides with particular binding characteristics, affinities for particular substrates, surfaces, or substances, or with some other well-defined chemical or physical characteristics. In a first step 1702, a set of candidate polypeptides 1704 is generated. The candidate polypeptides may be generated to exhibit desired characteristics, when possible, such as by phage-display techniques or other combinatorial biology or chemistry techniques, or may alternatively be generated at random or by computational selection from databases of already characterized polypeptides. Next, in a second step 1706, a polypeptide is synthesized for each of the sequences in the set of sequences 1704 not already characterized with respect to the current design goals. The synthesized polypeptides are then evaluated for the desired chemical and physical characteristics, such as by determining a binding constant with respect to a particular substrate, surface, or substance. The evaluation allows the set of sequences 1704 to be partitioned into different groups with respect to the evaluated chemical or physical characteristic. As one example, following evaluation of the synthesized polypeptides, the sequences may be partitioned into a group of strong binders 1708, medium-strength binders 1710, and weak binders 1712. Next, in a third step 1714, PSS and STSS scores can be computed, as shown in FIG. 17 1716, for each group and for all possible pairs of groups. The STSS scores indicate how similar the sequences in each group are to one another, and the TSS scores indicate the similarity between the sequences in each of the different groups. Using these computed values, the polypeptide scoring function can be optimized, in step 1718, to produce an improved polypeptide scoring function, in FIG. 17 represented by TSS* and STSS* 1720. The new polypeptide scoring function TSS* can then be used to evaluate a new, larger set of randomly generated polypeptide sequences in order to select a new group of theoretical strong binders S′ 1722. This new group may have the desired chemical and physical properties, and may therefore represent the result of the method. However, the new sequences may also be combined with the previous set of strong-binding sequences 1708 to produce an enhanced group of strong-binding sequences S* 1724, which can be used as a basis for another round of analysis and polypeptide scoring function optimization in order to generate a still more improved polypeptide scoring function TSS** for selecting additional polypeptide-sequence candidates from additional computationally generated sequences.

The optimization step 1718, for one embodiment of the present invention, may be expressed as:

$${PSS}^{*} = \frac{arg max}{S , gap ( ) , openP , extensionP} f ( )$$

In this case, an objective function η( ) is optimized with respect to the similarity matrix S, the gap function g( ), and the values openP and extensionP in order to produce an improved PSS scoring function. The objective function for the optimization may be as simple as:

η( )=STSS_{S}−TS_{S,W}

which steers optimization towards an improved PSS that provides a large self-TSS score for the strong binding group and a small TSS score computed between the strong binding group and weak binding group, or may be more complex, such as:

η( )=(STSS_{S})^{3/2}+(STSS_{S}−TSS_{S,M})+(STSS_{S}−TSS_{S,W})

Many different optimization methods may be used in order to generate and improve PSS, PSS*, by optimizing the similarity matrix S, gap function gap(), and gap opening and gap-extension penalties openP and extensionP, respectively. The following C++-like pseudocode provides an indication of one possible optimization technique. This technique both recursively and iteratively searches for a series of perturbations randomly introduced into the similarity matrix S, gap function gap(), and gap-opening and gap-extension penalties openP and extensionP in order to optimize the objective function η( ).

First a number of constants are declared:
1 const int null=0;
2 const int maxForwardSearches=10;
3 const int maxIterations=10;
4 const int maxDepth=10;
   The search is tree-like, in nature, and the fan-out at each node is controlled by the constant “maxForwardSearches.” The depth of the tree is controlled by the constant “maxDepth.” Random perturbations are not guaranteed to improve the PSS, and therefore the constant “maxIterations” limits the number of perturbations tried, for each node of the tree, in order to find perturbations that improve the PSS. The constant “null” is a return value for functions that return pointers.

A structure type Args is next declared:

1 typedef struct args
2 {
3 int (*g)( );
4 int openP;
5 int extensionP;
6 int S[10][10];
7 int fval;
8 } Args;

An instance of the structure Args contains instances, or pointers to instances, of the gap function, similarity matrix, gap-opening penalty, and gap-extension penalty, as well as a numeric objection-function score, “fval,” computed using the values contained in the instances of the gap function, similarity matrix, and gap-opening and gap-extension penalties.

Three functions are declared, but not implemented, in the interest of brevity:

1 void copy (Args* a, Args* b)
2 {
3 }
1 void perturb(Args* a)
2 {
3 }
1 int f(Args* a)
2 {
3 }

The function “copy” copies the values in a first instance of the structure type Args to a second instance of the structure type Args, allocating memory as needed. The function “perturb” introduces random perturbations in one or more of the gap function, similarity matrix, and gap opening and gap-extension penalties. Of course, the number and types of perturbations introduced are implementation dependent, and may critically affect the efficiency and operability of the optimization method. The function “f” is an implementation the objective function η( ) discussed above with reference to the optimization problem, and carries out required computation using a set of sequences corresponding to characterized polypeptides. Any of a large variety of different objective functions may be employed, including those discussed above.

Finally, an implementation of the function “optimize” is provided:

| | |
|---|---|
| 1 | Args* optimize(Args* a, int depth) |
| 2 | { |
| 3 | int i, j = −1; |
| 4 | int newfval; |
| 5 | int numForward = 0; |
| 6 | Args* nxtRes; |
| 7 | Args* results[maxForwardSearches]; |
| 8 | |
| 9 | if (depth > maxDepth) return (null); |
| 10 | |
| 11 | results[numForward] = new Args; |
| 12 | |
| 13 | for (i = 0; i < maxIterations; i++) |
| 14 | { |
| 15 | copy (a, results[numForward]); |
| 16 | perturb(results[numForward]); |
| 17 | newfval = f(results[numForward]); |
| 18 | if (newfval > a->fval) |
| 19 | { |
| 20 | nxtRes = optimize(results[numForward], depth + 1); |
| 21 | if (nxtRes != null) |
| 22 | { |
| 23 | delete results[numForward]; |
| 24 | results[numForward] = nxtRes; |
| 25 | } |
| 26 | if (numForward == maxForwardSearches) break; |
| 27 | else |
| 28 | { |
| 29 | numForward++; |
| 30 | results[numForward] = new Args; |
| 31 | } |
| 32 | } |
| 33 | } |
| 34 | for (i = 0; i < numForward; i++) |
| 35 | { |
| 36 | if (results[i]->fval > a->fval) |
| 37 | { |
| 38 | newfval = results[i]->fval; |
| 39 | if (j >= 0) delete results[j]; |
| 40 | j = i; |
| 41 | } |
| 42 | else delete results[i]; |
| 43 | } |
| 44 | if (j >= 0) return results[j]; |
| 45 | else return null; |
| 46 | } |

This function is initially called with the current gap function, similarity matrix, gap opening and gap-extension penalties of the current PSS as well as an indication of the maximum depth for the search. When called, the function determines whether the current depth is greater than the maximum allowed depth, on line 9. If so, the function returns a null pointer, indicating that no further searching along a current search path can be carried out. In the for-loop of lines 13-33, a number of perturbed instances of the initial set of arguments are generated and evaluated with respect to the objective function. On lines 15-17, a new set of arguments is generated by random perturbation and evaluated with respect to the objective function. If the objective function returns a value greater than the value of the objective function input to the current instance of the routine “optimize,” then, in lines 18-32, the routine “optimize” is recursively called to search forward from the new argument instances. If the recursive call the routine “optimize” produces an even better set of arguments, as determined on line 21, then that set of arguments replaces the set of arguments generated on lines 15-17. Finally, in the for-loop of lines 34-43, the best of any newly generated argument instances is selected, if any, and returned to the calling entity of the current instance of the routine “optimize,” generally another instance of the routine “optimize.”

The above-described optimization routine does not guarantee an optimal solution, or even any improvement in the current PSS. However, depending on the values of the parameters “maxForwardSearches,” “maxIterations,” and “maxDepth,” the perturbation state space may be searched up to some selected level of completeness and depth for more optimal similarity matrixes, gap functions, and gap opening and gap-extension parameters, and an improved PSS will be found. The optimization problem is non-convex, and thus not generally amenable to simple linear optimization methods.

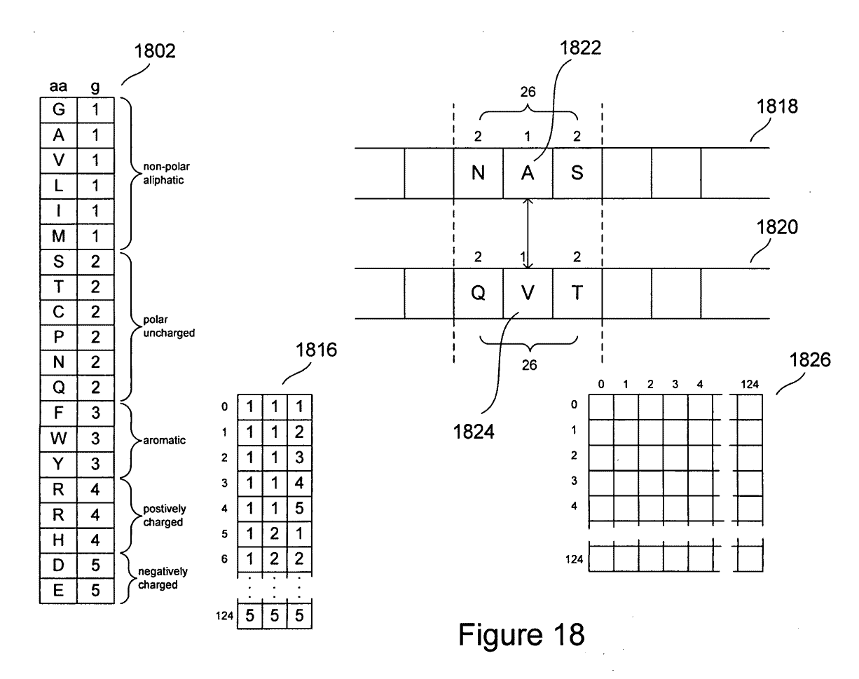

There are many possible polypeptide scoring functions that can be employed in embodiments of the present invention in order to evaluate polypeptide sequences for theoretical chemical and physical properties. As one example, consider the similarity matrix described with reference to FIG. 8A. This similarity matrix, when used in computing the PSS as described with reference to FIGS. 9-14, results in comparison only of the similarities of amino-acid monomers at identical positions within two different polypeptide sequences. FIG. 18 illustrates a different type of similarity matrix that may be used in an alternate PSS. As shown in FIG. 18, the 20 common amino acids may be partitioned into five different groups, by partitioning table 1802. These groups include amino acids with: (1) non-polar, aliphatic side chains; (2) polar, uncharged side chains; (3) aromatic side chains; (4) positively charged side chains; and (5) negatively charged side chains. Next, each possible consecutive subsequence of three amino-acid residues can be expressed as a metacharacter selected from the table of metacharacters 1816. Rather than using the identity of the amino acids to generate metacharacters, the groups to which the amino acids belong, indicated by an integer ranging from 1 to 5, are used to form each metacharacter. There are therefore 125 different metacharacters that describe all possible three-amino-acid sequences within a polypeptide sequence. When a first sequence 1818 is compared with a second sequence 1820, rather than computing a similarity value for pairs of amino-acid monomers at common positions within the sequences, a comparison can be made between the metacharacter centered at each position. In an example shown in FIG. 18, the alignment scoring function has reached amino acid 1822 in the first sequence and amino acid 1824 in the second sequence. Rather than looking up the similarity matrix value S_{a,v}, as would be done in the previously described alignment scoring function, the metacharacter centered at these positions is computed for both the first sequence and the second sequence. The metacharacter is computed by assigning group numbers to each of the amino acids in the three-amino-acid subsequences, and then computing the number of the metacharacter corresponding to the three group numbers. Thus, a similarity matrix for comparing metacharacters to metacharacters 1826 can be employed rather than the previously described similarity matrix for comparing single amino acids to one another. The new similarity matrix 1826 is considerably larger than the previously described similarity matrix, and thus many more polypeptide sequences would need to be compared in order to generate statistically relevant values for the cells of the larger similarity matrix. However, when a metacharacter comparison is employed, not only is the pairwise similarity of two amino acids considered but, instead, characteristics of the two amino acids as well as their immediate neighbors are compared. Even larger metacharacters, comprising five, seven, or a greater number of amino acids, might be employed, although the size of the corresponding similarity matrix quickly becomes prohibitively large. Note that a gap function can still be employed, in the case that either symbol within either sequence at the current position contains a gap symbol, and a modified comparison can be undertaken when either metacharacter contains a gap symbol. Alternatively, gap symbols may be included in an expanded metacharacter set.

In the above-described PSS, the similarity matrix is the basis for the only comparison made in the alignment-scoring function. However, many additional considerations may be embodied in the alignment-scoring function.

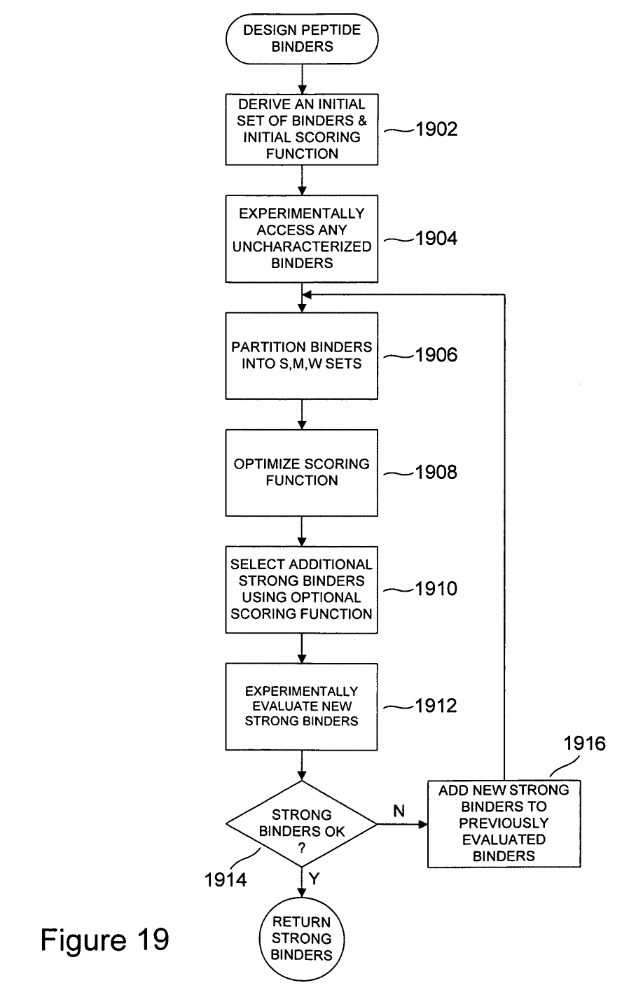

FIG. 19 provides a control-flow diagram for one particular embodiment of the present invention. In step 1902, an initial set of polypeptide sequences and an initial scoring function are received. In step 1904, any uncharacterized binders are experimentally characterized so that, in step 1906, all of the current set of binders can be partitioned into the above-described sets S, M, and W. Then, in step 1908, the initially received scoring function is optimized, according to the optimization method described above, or by any of many other optimization methods. In step 1810, additional polypeptide sequences are computationally generated, generally randomly, and additional strong binding sequences are selected from the generated sequences using the optimized scoring function. In step 1812, the strong binders are experimentally evaluated. If the current set of strong binders meets the design goals, as determined in step 1914, then the design method returns the current set of strong binders. Alternatively, the set of strong binders, and possibly any of the other newly evaluated polypeptide binders, are added to previously evaluated polypeptide binders, in step 1816, and the scoring-function-optimization steps are repeated in order to produce an improved scoring function and in order to find an even better set of sequences. Evaluation can proceed until desired results are obtained, until a maximum number of iterations has been carried out, or until some other termination condition is satisfied.

### Exemplary Applications

There are myriad different applications for polypeptides with high affinities and specificities for binding particular types of surfaces, substrates, and substances. Polypeptides may be used as adhesives, masking compounds, universal inks, and even functional components within molecular-electronics analogs to conventional integrated circuits. Polypeptide therapeutic agents may be employed to promote directed growth of various types of tissues, including bones and teeth, and may be additionally used in various pharmaceutical-related applications. Because of the wealth of three-dimensional structures and side-chain functional groups available to designers of polypeptide compounds, polypeptides may be designed for any of a huge number of highly selective and specific applications in electronics, materials science, medicine, nanotechnology, and other areas.

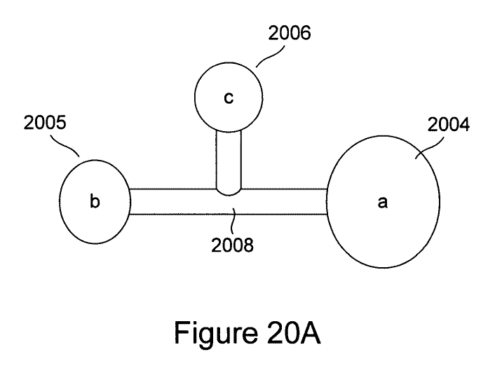

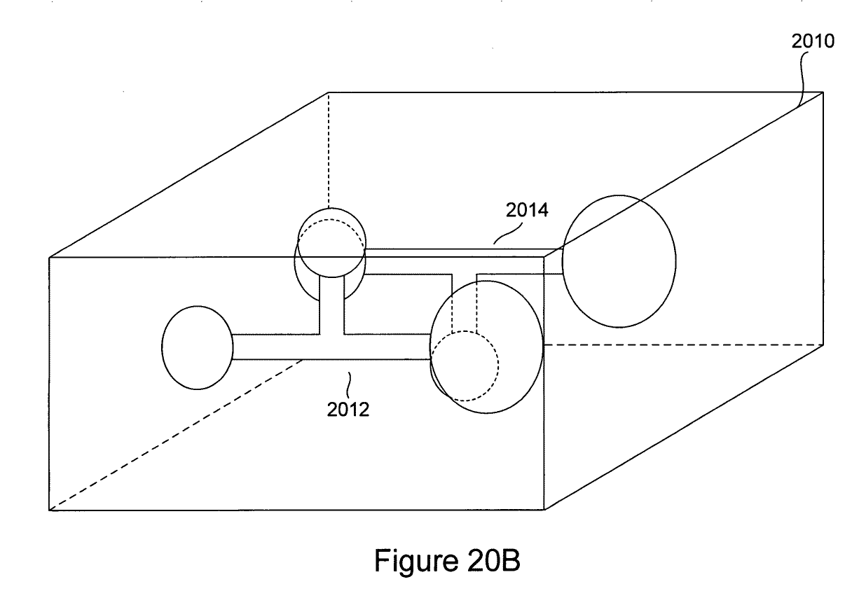

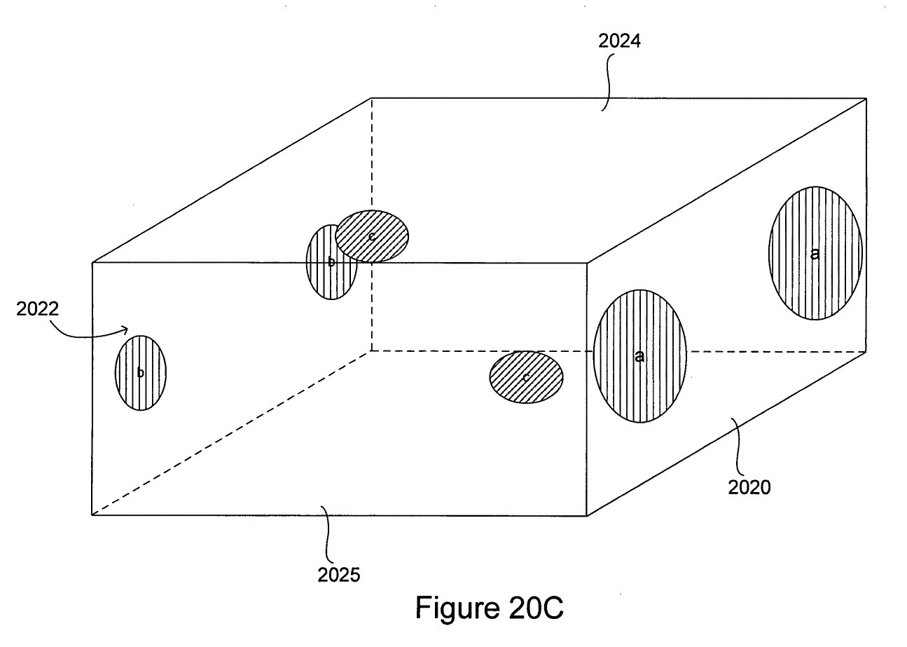

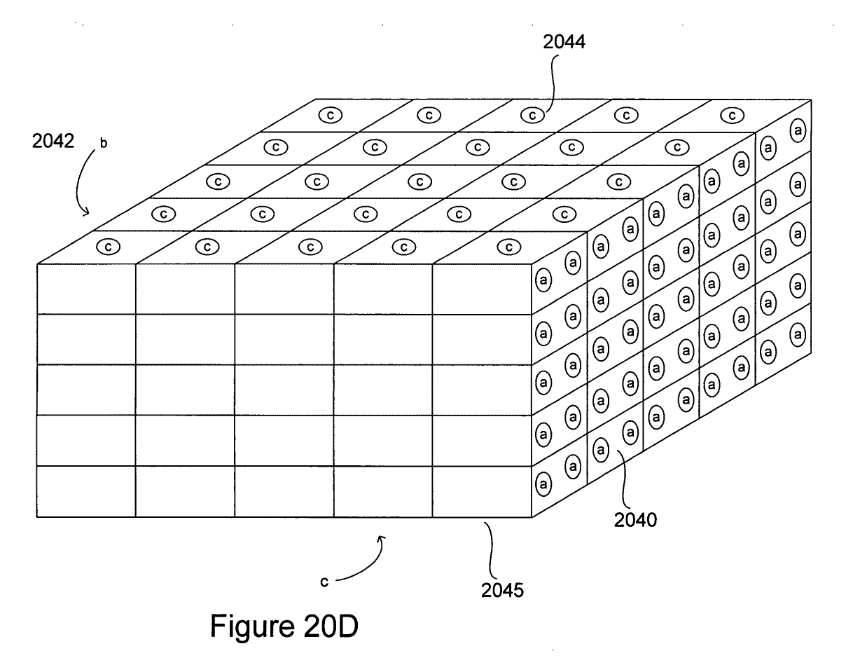

Next, several exemplary applications for designed polypeptide binders are provided. FIGS. 20A-D illustrate anisotropic properties of certain crystalline substances. FIG. 20A shows a hypothetical compound, with three different regions 2004-2006, labeled “A,” “B,” and “C,” respectively, with different chemical and/or physical properties held together by a more or less rigid molecular skeleton 2008. For example, region “A” may be polar or positively charged, while region “B” may be negatively charged and region “C” may exhibit aromatic characteristics. Note that the regions A, B, and C do not necessarily correspond to particular atoms or functional groups, but simply represent portions of a larger molecule.

When molecules crystallize, they form well-ordered arrangements with periodicities in arbitrarily selected directions. Crystalline compounds are characterized by a smallest repeating volume, referred to as a “unit cell.” FIG. 20B shows a hypothetical unit cell for a crystalline state of the compound abstractly illustrated in FIG. 20A. The unit cell is rectangular parallelepiped 2010 that includes two molecules 2012 and 2014. Note that the unit cell is an artificial, abstract concept, and that the crystalline compound contains only well-ordered molecules. When the unit cell is viewed from the outside with respect to the orientation of the molecules contained within it, as shown in FIG. 20C, the unit cell can be seen to be anisotropic, having a first side 2020 associated with the A portions of the molecules, a second, opposite side 2022 associated with the B portions of the molecules, and a second pair of sides 2024-2025 most associated with the C portions of the molecules. In a crystalline solid, the unit cells are stacked together into a three-dimensional lattice, as shown in FIG. 20D. In the case that the macroscale faces of a crystal of the crystalline substance align with unit-cell faces, as shown in FIG. 20D, the different faces of a crystal may exhibit different chemical and physical properties, with one face having A character 2040, another face 2042 having B character, and another pair of faces 2044-2045 having C character. In fact, macroscale crystal faces do not necessarily correspond, in orientation, to the faces of unit cells, but for many types of substances, the different faces of crystals exhibit often strikingly different chemical and physical properties due to the underlying anisotropy of the three-dimensional crystalline lattice and its contents.

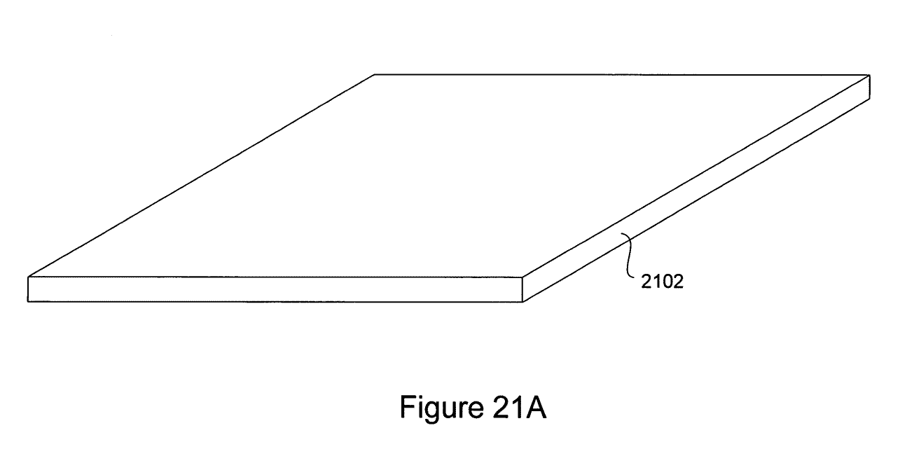

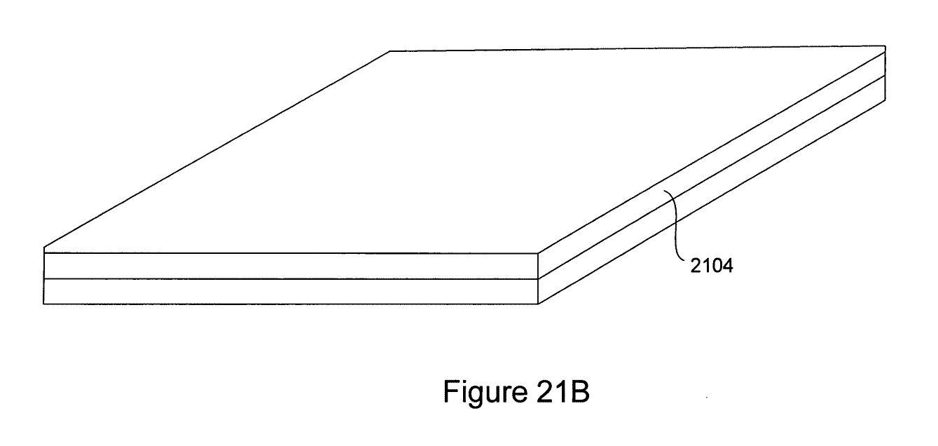

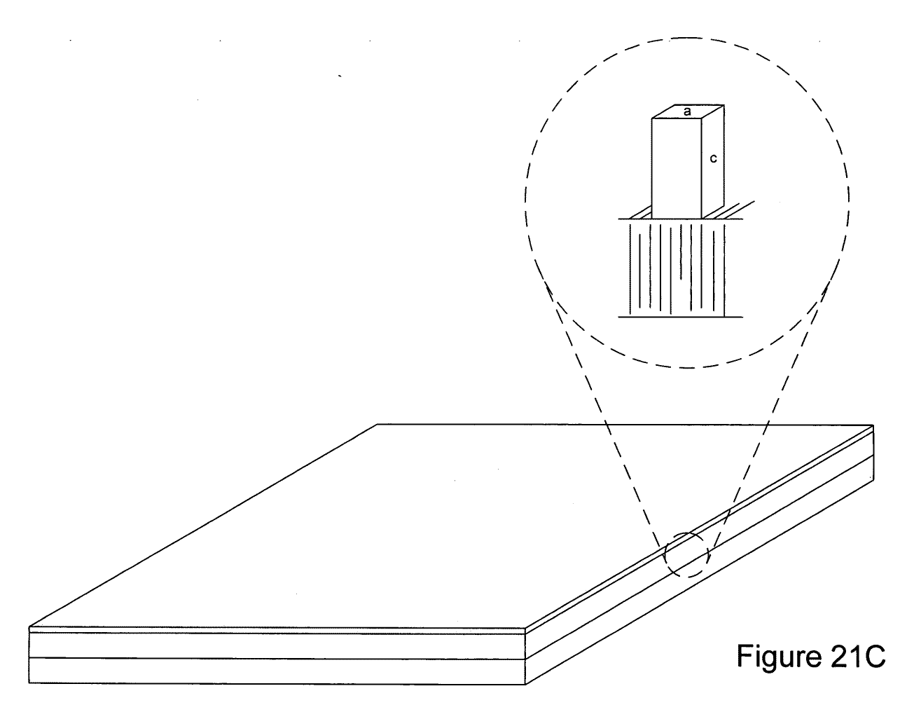

In many cases, crystalline materials in the form of small particles serve as extremely effective catalysts. Examples include the catalysts contained in catalytic converters within automobiles and powdered metal catalysts used in a variety of synthetic chemical reactions. Analysis of catalytic mechanisms often reveals that only one of a pair of faces of the crystals exhibit catalytic activity, while other faces of the crystals are essentially inert. It is often necessary to immobilize tiny catalytic crystals within membranes or on surfaces of reaction chambers or filters. However, in general, techniques used to immobilize the crystals result in random orientations of the crystals. In the case of 8-sided crystals, only one pair of sides of which are catalytic, the bulk catalytic activity of an immobilized surface or film of catalytic crystals may be only ¼ or less of the potential catalytic activity of the crystalline substance, due to the fact that, in many cases, the catalytic face is not properly oriented outward from the surface and therefore is not exposed to reactants. Recently, researchers have investigated ways to grow catalytic crystals so that the percentage of total surface of the crystals with catalytic activity is maximized. An alternative or complementary approach is to immobilize the catalytic crystals such that, in most cases, the catalytic surfaces are oriented outward from the surface on which the crystals are immobilized. FIGS. 21A-C illustrate a polypeptide-based approach to efficient immobilization of catalytic crystals. The process begins, in FIG. 21A, with a substrate 2102. In a first step, shown in FIG. 21B, a film of a polypeptide binder 2104 is laid down over the substrate. The polypeptide binder has been designed to have at least high specific affinity for a non-catalytic surface of a catalytic crystal and may, in addition, have been designed to have specific affinity for the substrate or surface. Then, as shown in FIG. 21C, the polypeptide film is exposed to a solution of catalytic crystals, preferentially binding to the non-catalytic surface of the crystals so that the catalytic surfaces are oriented outward and exposed to reactants in a reaction vessel, tube, filter, or other device that is coated with the catalytic crystals. In the example shown in FIG. 21C, the polypeptide film has high specific affinity for the B side of the catalytic crystals discussed with reference to FIG. 20D, therefore orienting the A side of the crystals, which exhibit a desired catalytic activity, outward, away from the surface and maximizing the catalytic activity of the immobilized catalytic crystals.

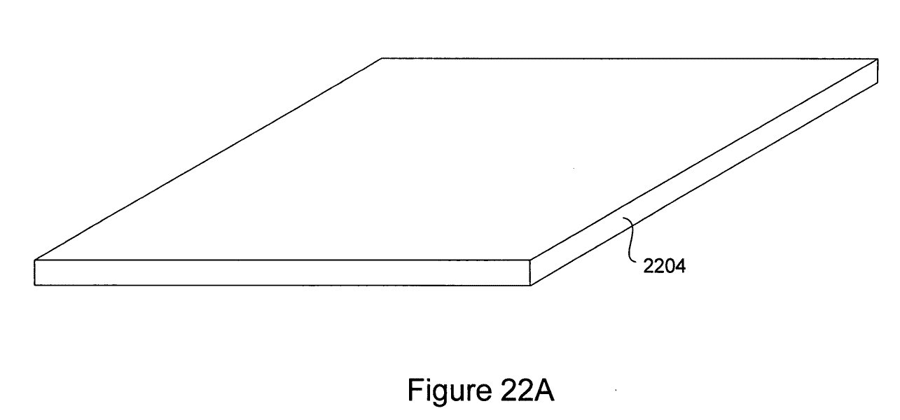

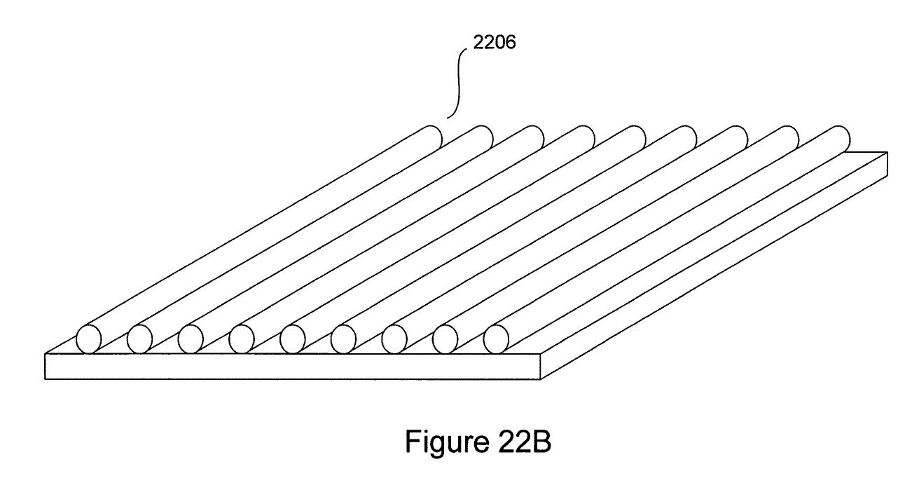

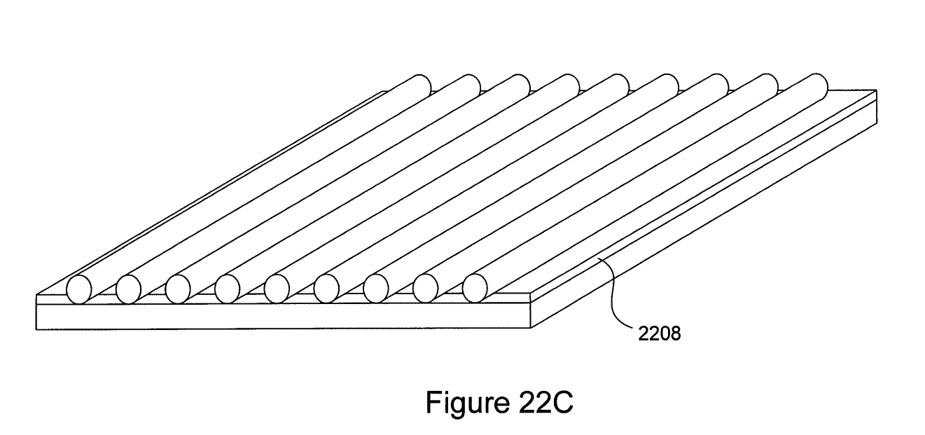

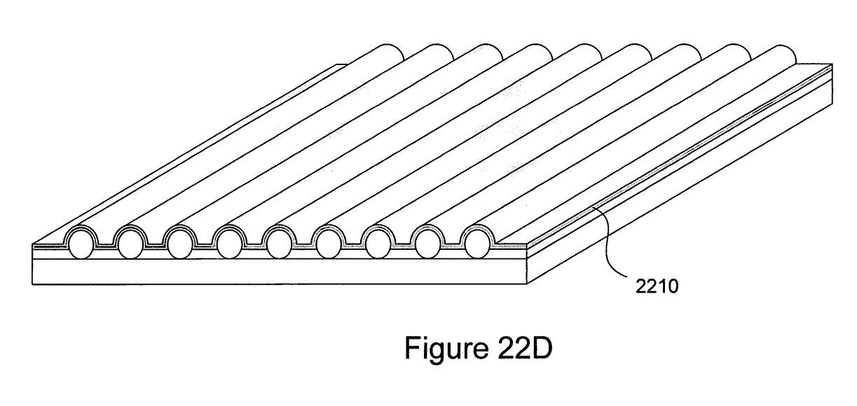

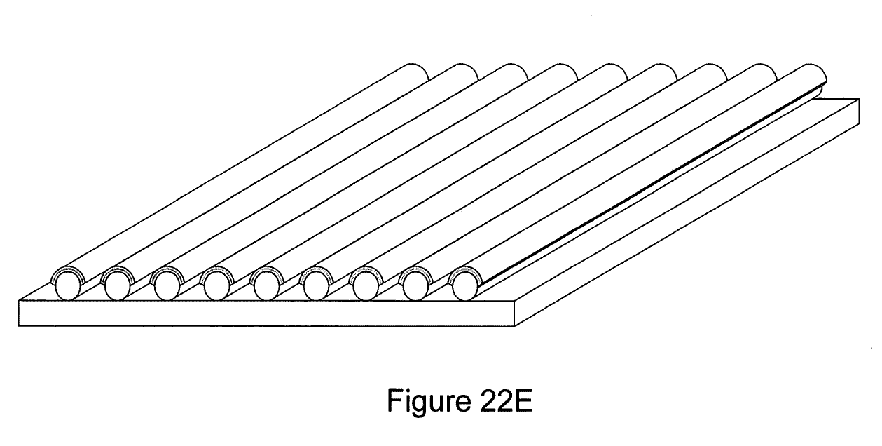

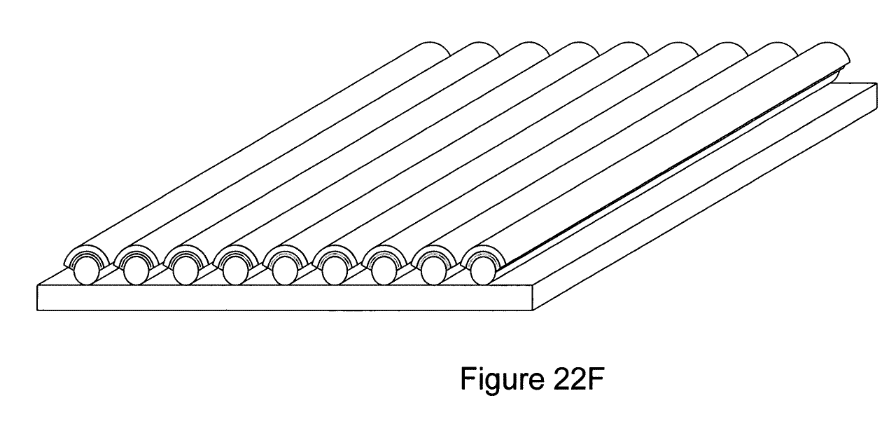

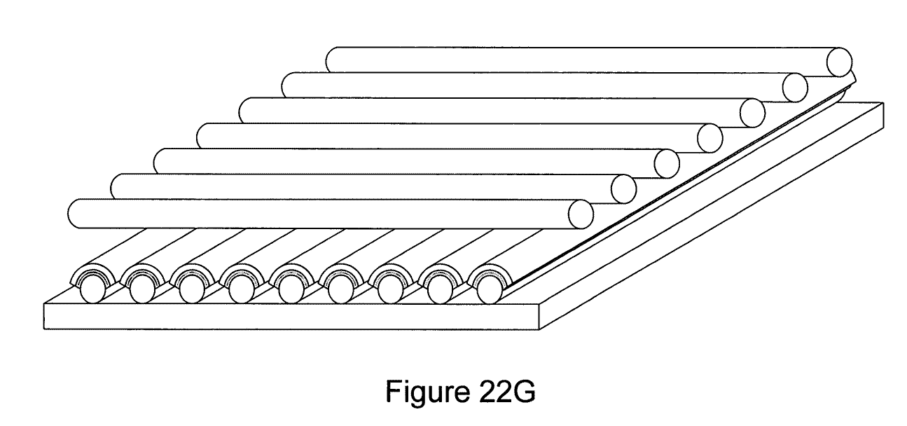

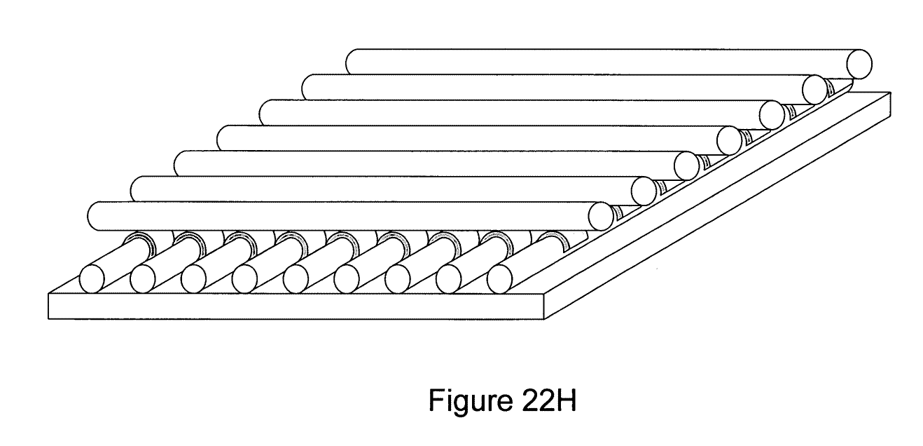

FIGS. 22A-H illustrate a second application for polypeptide binders having specific, high affinities for particular substrates. In the field of molecular electronics, nanowire crossbars are being developed as a foundation architecture for various microscale/nanoscale interface components, including demultiplexers. A nanowire crossbar generally contains two layers of parallel nanowires, the nanowires in the first layer approximately orthogonal to the nanowires in the second layer. Active substances at nanowire junctions provide diode-like or transistor-like connections between the nanowires. However, the nanowires are too small to be fabricated using conventional submicroscale photolithographic processes. Instead, nanowires may self-orient, parallel to one another, in thin films on a liquid surface and may then be applied by a Langmuir-Blodgett process to substrates. Reliably introducing an active substance at nanowire junctions, in a manufacturing process, may be problematic.

One hypothetical approach to nanowire-crossbar fabrication, using polypeptide binders, is shown in FIGS. 22A-H. First, as shown in FIG. 22A, a substrate is prepared 2204. Next, as shown in FIG. 22B, a first layer of oriented nanowires is deposited on the substrate. Then, as shown in FIG. 22C, a polypeptide binder with high specific affinity for the substrate, and no affinity for the nanowires, is deposited 2208 over the substrate surface not already covered by the nanowires. Next, as shown in FIG. 22D, an active substance 2210 is deposited over both the nanowires and the polypeptide film. In a next step, shown in FIG. 22E, a solvent-based approach may be used to remove the polypeptide film, along with the active-substance layer above the film, from the substrate, leaving the substrate with active-substance-coated nanowires. By removing the polypeptide film, the active substance is removed from the spaces between nanowires, so that the nanowires are electronically isolated from one another. Thus, the polypeptide film binds, under one set of conditions, and does not bind, under a second set of conditions, allowing the polypeptide film to be used as a lifting agent for removing active substance from undesired portions of the nascent nanowire crossbar.

In a next step, shown in FIG. 22F, a second type of polypeptide binder with strong affinity for the active substance is applied to the nascent nanowire crossbar, coating the surface of the previously deposited active substance that, in turn, coats the upper portions of the deposited nanowires. The second polypeptide film has affinity both for the active substance and for nanowires of a second, different set of nanowires. As shown in FIG. 22G, the second set of parallel nanowires is then deposited, roughly orthogonally, to the first set to form the nanowire crossbar. The second polypeptide substance acts as a very specific, divalent adhesive for binding the second set of nanowires to the active-substance-coated first set of nanowires. Then, in a final step shown in FIG. 22H, an etching process may be used to remove the active substance and second polypeptide film all portions of the nanowire crossbar other than those protected by etchant by the second set of nanowires. After etching, the active substance is properly sandwiched between nanowires at the nanowire junctions. The second polypeptide film is gently removed by a heating or solvent-based approach, or may be left, in place, if it does not interfere with electronic interconnection of nanowires. The second polypeptide film is thus employed as a bivalent adhesive to facilitate stable binding of the second layer of nanowires to the first layer of nanowires.

Many additional applications for polypeptide binders can be envisioned, as discussed above. In some cases, the polypeptide binders are transient intermediates in the manufacturing process, used to specifically coat, bind, and manipulate tiny components that cannot be mechanically or electronically manipulated. In other cases, the polypeptide binder may remain in the finished product as a passive or active component. Polypeptide binders may be thought of as highly specific Velcro™ films for binding nano-components, molecular components, or layers to one another.

### Experimental Results

The primary means by which inorganic binding peptides are currently discovered is by experimental techniques using biocombinatorics, such as cell surface and phage display. Adapting molecular biology protocols, here the peptide libraries are generated by inserting randomized nucleotides within genes coding cell surface or phage coat proteins. Following the introduction of the modified genetic material into the host, each cell or phage displays a different peptide motif on the surface; binding sequences are then selected through biopanning by exposing the library to the desired inorganic materials. Combinatorial biology phage or cell surface display (PD and CSD) techniques are used to generate sets of peptides that bind to a variety of inorganic surfaces. Peptides were for quartz and hydroxyapatite using Ph.D.-12 PD peptide library and for gold using FliTrx bacterial CSD library, both displaying 12 aa peptides. Immunofluorescent labeling is then used to determine the binding affinities of these peptides which are then classified into three main binding groups: strong, moderate, and weak. The goal is to exploit the sequence information inherent in these genetically selected peptides to develop a bioinformatics approach for knowledge-based design of new sets of peptides capable of binding to particular solid substrates with predictable affinity and specificity. It is assumed that the inorganic binding peptides recognizing a given material generated by a directed evolution technique have similar sequences. The principle of the bioinformatics design approach is that the sequences known to possess a particular functional property are grouped together, in this case, binding to an inorganic substrate with a specific affinity. For protein sequence comparison, scoring matrices, such as BLOSUM6221 and PAM25022, are used to bootstrap and optimize the improved discriminatory power of the similarity comparisons. The pairs of peptides have high pair-wise similarity scores when both are strong binders to an inorganic substrate and have low scores when one is a strong and the other is a weak binder. A peptide is then compared to a set of strong-binding sequences; if its total similarity score is high, then the new sequence is hypothesized as being a strong binder. To test the hypothesis, sets of quartz, hydroxyapatite, and gold binding peptides were used that were experimentally selected using either PD or CSD methods as a starting point for our sequence comparisons A scoring matrix was derived for each of the three inorganic substrates, namely QUARTZ I, HA I, and GOLD I, that were optimized to discriminate between strong and weak binders in each of the peptide sets, respectively. The total similarity score of each sequence set was then computed with respect to its corresponding strong binding sequences by using their specialized scoring matrices. This was accomplished by removing the peptide being evaluated from the strong binding set, if present, to prevent an artificial inflation of the similarity scores (i.e., leave-one-out cross validation). The sequences with the highest and lowest similarity scores were considered to represent the strongest and weakest binders, respectively. For the case of strong binding peptides, the accuracy of predicting the correct sequences is 80% (8/10), 69% (11/16), and 75% (6/8) for quartz, hydroxyapatite, and gold, respectively. The bioinformatics approach can accurately classify inorganic binding peptides, which can then used to generate new peptide sequences with predictable binding affinities and specificities. One million random sequences (total of 1.2×107 amino acids) were generated based on the observed amino acid frequencies in the library used for the phage display combinatorial selection. The total similarity scores between each of these sequences were then calculated and the strong binder groups were experimentally determined using the QUARTZ I, HA I, and GOLD I scoring matrices.

Three different independent experiments were performed to validate our predictions on binding affinities. Ten in silico designed peptides were used; six strong and four weak quartz binding peptides (QBPs), predicted using the QUARTZ I scoring matrix. Two peptides were first expressed from this set, one strong and one weak binding, on the pIII minor coat protein of M13 phage. A genetic insertion protocol was developed that utilizes a cloning vector and then a phage vector. Similar to the characterization of experimentally selected peptides, immunofluorescence analysis was carried out to assess the binding affinity of the new peptides. Finally, a quantitative technique, surface plasmon resonance (SPR) spectroscopy, was used to provide kinetics of binding for all designed strong and weak binding sequences. Consistent with the other two tests, the strong binding peptides displayed higher and weak binding peptides lower binding than the experimentally selected strongest-binding peptide sequence (RLNPPSQMDPPF). This bioinformatics approach can also be used for the design of peptides capable of selectively binding to one or more inorganic substrates. The total similarity scores of one million randomly generated peptides were calculated, simultaneously, to both the predicted and experimental quartz and hydroxyapatite binding sequences, respectively. Peptides capable of binding to quartz, hydroxyapatite, both or neither were selected. For experimental verification, two strong and two weak quartz binding sequences were selected that were also predicted to be strong or weak hydroxyapatite binders, respectively. Two strong and two weak hydroxyapatite-binding sequences were selected that were predicted to be strong or weak quartz-binding sequences, respectively. Seven out of eight predictions concurred with the experimental observation: two peptides bind specifically to quartz, and one peptide binds specifically to hydroxyapatite. These peptides may be used to differentiate one material from another on a molecular level. In addition, two peptides have affinity to both materials, and two peptides have no affinity to either, as predicted.

Biomolecular binding of a peptide to a solid could be due to either its absolute amino acid composition alone or its molecular conformation, i.e., structure. To test the importance of the former, a classifier based only on the overall amino acid compositions of the strong and weak binders was developed and compared with the classification using overall sequence information. When only the relative abundances of amino acids are used for classification, the accuracy of prediction, as well as the differentiation between the strong and weak binders, is significantly reduced, i.e. from 75% to 50%. The amino acid composition provides some information but it is not adequate to fully represent the peptide-solid interactions. Therefore, the sequential arrangement of amino acids (leading a specific molecular structure) of a given peptide should be the key in the binding processes compared to its total amino acid content. I

### Peptide Selection

Phage Display (Quartz and Hydroxyapatite Binding Peptides):

Quartz and hydroxyapatite binding peptides were selected from Ph.D. 12™ Phage Display Peptide Library (New England BioLabs Inc., USA, using quartz crystal or synthetic hydroxyapatite powder as target substrates. Prior to panning experiment, the quartz and hydroxyapatite surface were cleaned by sonication in a methanol/acetone mixture (50:50) and in isopropanol. Cleaned quartz crystal or hydroxyapatite powder were then incubated with phage-peptide library overnight in a phosphate/carbonate (PC) buffer (pH 7.4), containing 0.1% detergent (Tween 20 and Tween 80, Merck, USA) at room temperature with constant rotating. In general panning selection: quartz crystal and hydroxyapatite powder were washed 10 times with PC buffer to remove the non-specifically or weakly bound phages gradually increasing the detergent concentration from 0.1% up to 0.5%, the bound phages were then eluted by 0.2 M Glycine—HCI (pH 2.2) buffer containing 1 mg/ml BSA solution, 0.02% Sodium Dodecyl Sulphate (SDS), IM Sodium Chloride (NaCI), 100 mM Dichloro-Diphenyl-Trichloroethane (DDT), 7 mM Tris (chloroethyl) phosphate (TCEP) and 100 mM Mercaptoethanol (ME), eluted phages were transferred to an early-log phase E.coli ER2738 culture, amplified for 4 hours at 37° C. and purified by polyethylene glycol (PEG) precipitation, purified phages were then used for subsequent selection round. Single phage clones were selected from each round from LBAgar media containing 5-bromo-4-chloro-3-indolyl-β-D-galactopyranoside (Xgal) and Isopropyl-β-D-thiogalactopyranosid (IPTG), amplified and amino acid sequence of the randomized polypeptide segment was identified by DNA sequencing. Binding affinity of single phage clones were then characterized in immunofluorescence microscopy experiment.

Cell Surface Display (Gold Binding Peptides):

Novel gold-binding peptides were selected from FliTrx bacterial surface library (Invitrogen) (Ref: Lu). 99.9% pure Au foils (Goodfellow Corp, PA, USA) previously cleaned by sonication in methanol/acetone mixture (50:50) and in isopropanol, were used as a target for novel peptide selection. Five rounds of selection were applied in the entire panning experiment for gold binding clones enrichment following manufacture's instruction, except for an optimized elution step: also recovering still bound cells after elution step (the shearing the cells from target by vortexing) by adding the Au target to IMC medium and incubating overnight at 25° C. and shaking 250 rpm. Eluted amplified cells were then used for subsequent selection round. Serial dilutions of preinduced cultures after each selection round were plated onto RMG plates and incubated overnight at 30° C. for single clone selection and DNA sequencing. The binding affinity of isolated 50 clones was further characterized in fluorescent microscopy experiment.

### Fluorescence Analysis

Classification of phage and cell clones into strong, moderate and weak binder groups was carried out according to fluorescent microscopy binding experiment: aliquots of phage clones (˜1010 p.f.u.) were incubated with quartz and hydroxyapatite powder samples (1 mg) overnight, unbound phage were washed away with a sterile phosphate/carbonate (PC) buffer (55 mM KH2PO4, 45 mM Na2CO3, 200 mM NaCI), bound phage were incubated with mouse anti-M13 monoclonal antibody 1 □g/mL (Amersham Bioscience) in PC buffer, previously incubated with anti-mouse Alexa 488-fluorophore labeled Fab antibody fragment (Molecular Probes), for 30 min in dark, excess antibody was washed away with PC buffer. Similarly, aliquots of induced cell clones (OD=0.5) were labeled by 8.5 □M nucleic-acid fluorescent dye SYTO9 (Molecular Probes) and incubated with Au surface (5×5 mm) deposited on glass surface for 1 hr, unbound cells were washed away with sterile DI water. Bound phage and cells were visualized on Nikon TE-2000U Fluorescent Microscope (Nikon) using MetaMorph® Imaging System Ver. 6.2 (Photometrics UK Ltd., UK, formerly Universal Imaging Co., USA) fitted with relevant fluorescent filter.

### Surface Plasmon Resonance Spectral Analysis

Designed peptides were synthesized with a purity >95%. For adsorption characterization of the designed peptides on SiOx, a temperature controlled Kretschmann configuration surface plasmon resonance (SPR) spectrometer, developed by Radio Engineering Institute Czech Republic, was used.30 A gold SPR chip was first coated with 4 nm SiOx using ion-beam sputter coater (Gatan Inc, PA), operated at 6 keV with a 10 mA/cm2 ion current density and under 6×10−5 Torr vacuum. Peptides were dissolved in a PC buffer solution (pH=7.4) with a final concentration of 4 M. The buffer and peptide solutions were flown through a four-channel flow cell at a flow rate of 100 ml/min. After the baseline was established with the buffer solution, the peptide solutions were flown to monitor the binding of the peptides at 25° C. The amount of bound peptides on the substrate surface was then determined by the usual procedure of correlating it with the amount of shift in the dip position of changing refractive index due to the molecular adsorption on the substrate. A higher shift reflects larger amount of molecular adsorption and a sharp increase reveals faster binding.

### Quantum Dot Immobilization

To demonstrate the binding characteristics of the designed peptides on inorganic substrates, streptavidin (SA) functionalized quantum dots (Invitrogen, USA) were used that preferentially immobilize on the biotin-conjugated peptides through biotin-streptavidin interaction. To accomplish this, 2.5-3 μm spherical quartz particles (Nanostructured & Amorphous Materials Inc., USA) (1 mg) were incubated with biotinylated peptides (60 μM) in PC buffer to assemble the peptides onto the powder surface. Quartz particles were washed three times with PC buffer and incubated with SA functionalized Cd/Se quantum dot solution (10-2 μM) for 40 minutes at room temperature. The particles were then washed successively with PC buffer and sterile DI water, transferred to a microscope slide and examined under fluorescence microscope. An approximate surface coverage on the powder surface was calculated using MetaMorph® Imaging System Ver. 6.2 (Photometrics UK Ltd., UK, formerly Universal Imaging Co., USA) by comparing the calculated surface area of the powder in the bright field image to the calculated coverage in the fluorescence image. Since the SA-functionalized quantum dots are immobilized on the particle surface through biotinylated peptides, the fluorescence intensity is related to the surface coverage of the peptides.

### The Expression of the Designed Peptides on M13 Phage

Starting from the oligonucleotide forms of the designed novel quartz binding peptides, one strong binding peptide (SPPRLLPWLRMP) and one weak binder (EVRKEVVAVARN) were displayed on the minor coat protein pIII. The random library insertion position of the M13 phage was used for the expression of the designed peptides. Single stranded oligonucleotide was annealed with extension primer (5′ CATGCCCGGGTACCTTTCTATTCTC-3′, NEB Inc. Boston, USA) with the reaction conditions starting from 95° C. and cooling to 30° C. nearly in one hour. Extension was performed with Klenow Enzyme (NEB Inc., Boston, USA) at 45° C. for 20 min., following 15 min. at 65° C. Extended reaction product was cloned into recovered pDrive cloning vector for DNA amplification. Plasmid DNAs containing the desired peptide sequences were digested with 5 U of Eag I and Acc65 I restriction enzymes, and ligated into M13KE phage vector. Following the ligation and transformation processes, phages were amplified with E.coli ER2738. The sequences are confirmed by using ssDNAs of phages.

Although the present invention has been described in terms of particular embodiments, it is not intended that the invention be limited to these embodiments. Modifications within the spirit of the invention will be apparent to those skilled in the art. For example, although the above discussion has focused primarily on polypeptide binders, polypeptides can be designed to have any of many different physical and chemical properties by embodiments of the present invention. In addition, additional artificial or uncommon, naturally occurring amino acids can be incorporated into polypeptides designed by embodiments of the present invention by, for example, expanding the similarity matrix used to compute the PSSs. The method embodiments of the present invention may comprise both computational routines and methods as well as chemical or biochemical synthetic and analytical methods. The computational methods may be implemented using any of numerous programming languages for execution on any of many computing platforms, with variation in any of many different programming parameters, including modular organization, data structures, control structures. and other such parameters.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for designing polypeptides having specific, desired chemical and physical properties, the method comprising:
establishing the desired chemical and physical properties;
generating an initial set of polypeptide sequences as the initial, currently considered set of polypeptide sequences and storing the identified additional polypeptide sequences in a computer-readable medium;
generating an initial polypeptide-scoring function as the initial, currently considered polypeptide-scoring function; and
iteratively
characterizing any of currently considered set of polypeptide sequences not already characterized with respect to the desired chemical and physical properties,
partitioning the currently considered set of polypeptide sequences according to their chemical and physical properties,
optimizing the currently considered polypeptide-scoring function based on consideration of the partitioning of the currently considered set of polypeptide sequences according to their chemical and physical properties to produce a new, currently considered polypeptide-scoring function, and
applying the new, currently considered polypeptide-scoring function to a set of additional polypeptide sequences to identify additional polypeptide sequences with the desired chemical and physical properties, storing the identified additional polypeptide sequences in a computer-readable medium.

2. The method of claim 1 wherein the desired chemical and physical properties include one or more of:
a specific affinity, within a range of affinities, for a particular substrate, surface, or substance; and
no affinity for a particular substrate, surface, or substance.

3. The method of claim 1 wherein the currently considered polypeptide-scoring function computes a similarity between a polypeptide sequence and the sequences of a set of polypeptides having desired chemical and physical properties.

4. The method of claim 3 wherein the polypeptide-scoring function computes a similarity between a polypeptide sequence and the sequences of a set of polypeptides having desired chemical and physical properties by computing a pairwise similarity score using a sequence alignment technique that employs a similarity matrix.

5. The method of claim 3 wherein the polypeptide-scoring function computes a similarity between a polypeptide sequence and the sequences of a set of polypeptides having desired chemical and physical properties by computing a metacharacter similarity score using a sequence alignment technique that employs a metacharacter similarity matrix.

6. The method of claim 3 wherein applying the new, currently considered polypeptide-scoring function to a set of additional polypeptide sequences to identify additional polypeptide sequences with the desired chemical and physical properties further includes generating the set of additional polypeptide sequences by:
random sequence generation;
pseudo-random sequence generation;
selecting sequences from a database of sequences;
generating sequences based on theoretical consideration of the specific, desired chemical and physical properties.

7. A computer-readable medium encoded with instructions that implement portions of the method of claim 1, including:
partitioning a currently considered set of polypeptide sequences according to their chemical and physical properties,
optimizing a currently considered polypeptide-scoring function based on consideration of the partitioning of the currently considered set of polypeptide sequences according to their chemical and physical properties to produce a new, currently considered polypeptide-scoring function, and
applying the new, currently considered polypeptide-scoring function to a set of additional polypeptide sequences to identify additional polypeptide sequences with desired chemical and physical properties.

7. A method for determining whether or not a particular polypeptide is likely to have specific, desired chemical and physical properties, the method comprising:
establishing the desired chemical and physical properties;
generating a polypeptide-scoring function;
applying the polypeptide-scoring function to a polypeptide sequence that describes the particular polypeptide to compute a score; and
returning the score to a user for evaluation.

8. The method of claim 7 wherein the polypeptide-scoring function computes a total similarity score by:
summing individual similarity scores computed for pairwise comparison of the polypeptide sequence of the particular polypeptide with each of a set of polypeptides that are known to exhibit the specific, desired chemical and physical properties; and
normalizing the sum of the individual similarity scores by dividing the sum by the number of computed individual similarity scores.

9. The method of claim 8 wherein an individual similarity score, which compares the sequence of a first polypeptide with the sequence of a second polypeptide, is computed by:
computing a best alignment of the first and second polypeptide sequences; and
returning as a similarity score an alignment score for the first polypeptide sequence aligned with the second polypeptide sequence.

10. The method of claim 8 wherein the alignment score is computed as a sum of individual terms, each individual term corresponding to a different symbol pair within the aligned sequences, one symbol of the pair occurring in the first polypeptide sequence and the other symbol of the pair occurring in the second polypeptide sequence, individual term computed as:
the value of a gap function, when the symbol pair contains a gap symbol; and
a value of a similarity-matrix element, within a two-dimensional similarity matrix, indexed by the two symbols.

11. The method of claim 8 wherein the alignment score is computed as a sum of individual terms, each individual term corresponding to a different metacharacter pair within the aligned sequences, each metacharacter of the pair centered at a position of a symbol within the aligned sequences, one metacharacter of the pair occurring in the first polypeptide sequence and the other metacharacter of the pair occurring in the second polypeptide sequence, individual term computed as:
the value of a gap function, when either symbol at the position contains a gap symbol; and
a value of a similarity-matrix element, within a two-dimensional similarity matrix, indexed by the two metacharacters.


SEQUENCE LISTING (8 sequences)

SEQ ID NO: 1 - protein, 7 aa, Artificial Sequence
  polypeptide platinum binder
PTSTGQA

SEQ ID NO: 2 - protein, 7 aa, Artificial Sequence
  polypeptide platinum binder
QSVTSTK

SEQ ID NO: 3 - protein, 12 aa, Artificial Sequence
  polypeptide quartz binder
RLNPPSQMDPPF

SEQ ID NO: 4 - protein, 12 aa, Artificial Sequence
  polypeptide quartz binder
SPPRLLPWLRMP

SEQ ID NO: 5 - protein, 12 aa, Artificial Sequence
  polypeptide quartz binder
EVRKEVVAVARN

SEQ ID NO: 6 - DNA, 25 bp, Artificial Sequence
  extension primer
catgcccgggtacctttctattctc

SEQ ID NO: 7 - protein, 14 aa, Artificial Sequence
  hypothetical sequence for illustration
AQGHNALKKRMYVT

SEQ ID NO: 8 - protein, 14 aa, Artificial Sequence
  hypothetical sequence for a figure
ANGNNALRMFVTCF